(19) United States
(12) Patent Application Publication
(10) Pub. No.: US 2022/0049967 A1
(43) Pub. Date: Feb. 17, 2022

(54) PROMOTING RIDER SAFETY IN SHARED MOBILITY SPACE

(71) Applicant: Honda Motor Co., Ltd., Tokyo (JP)

(72) Inventor: Robert Uyeki, Torrance, CA (US)

(21) Appl. No.: 16/992,575

(22) Filed: Aug. 13, 2020

(51) Int. Cl. G01C 21/34; G08G 1/01; G06Q 50/30; G06Q 10/04; G06Q 50/26; G06Q 30/02; B60W 30/18; G01C 21/36; B60W 50/14

(52) U.S. Cl. CPC G01C 21/3492; G08G 1/0125; G06Q 50/30; G06Q 10/047; G06Q 50/265; B60W 2050/146; B60W 30/18009; G01C 21/3626; G01C 21/3691; B60W 50/14; B60W 2555/60; G06Q 30/0284

(57) ABSTRACT

An electronic apparatus to promote rider safety is provided. The electronic apparatus receives a trip plan associated with a user identifier. The trip plan includes a current travel route of a micro-mobility vehicle associated with a shared mobility service. The electronic apparatus determines incident information associated with a number of past traffic incidents on at least one portion of the current travel route. The electronic apparatus controls a display device to display an option to replace the current travel route with a safer alternate route. The electronic apparatus receives a user input that includes a selection of the displayed option. The electronic apparatus determines a discount applicable on an initial trip cost associated with the trip plan based on received user input and controls the display device to display, based on the determined discount, an incentive including a final trip cost associated the trip plan.

### BACKGROUND

Advancements in micro-mobility have paved a way for development of shared mobility services, such as a scooter renting service. Such services may offer micro-mobility vehicles (such as electric scooters) on a pay-as-you-go basis or a subscription model for a short distance transportation (also referred to as a last mile transportation).

In some scenarios, an electronic device (such as a mobile device) may include an application associated with a shared mobility service. In order to book a micro-mobility vehicle and start using the micro-mobility vehicle for a ride, the application may allow a user to sign up to register with the shared mobility service or sign-in to an existing account with the shared mobility service. The application may generate a travel route based on a travel destination location to allow the user to verify the route and to track the movement of the vehicle. There may be a history of traffic incidents related to the micro-mobility vehicle on sections of the generated travel route. It may be possible that such incidents may have an impact on the safety of the user riding the micro-mobility vehicle, especially if the user is inexperienced or is unaware of such incidents.

Further limitations and disadvantages of conventional and traditional approaches will become apparent to one of skill in the art, through comparison of described systems with some aspects of the present disclosure, as set forth in the remainder of the present application and with reference to the drawings.

### SUMMARY

According to an embodiment of the disclosure, an electronic apparatus to promote rider safety in a shared mobility space is provided. The electronic apparatus may include circuitry that may receive a trip plan associated with a user identifier. The trip plan may include a current travel route of a micro-mobility vehicle associated with a shared mobility service. The circuitry may determine incident information associated with a number of past traffic incidents on at least one portion of the current travel route and may control a display device associated with the micro-mobility vehicle, to display an option to replace the current travel route with a safer alternate route. The option to replace the current travel route may be displayed based on the determined incident information. The circuitry may further receive a user input that may include a selection of the displayed option and may further determine a discount applicable on an initial trip cost associated with the trip plan based on the received user input. The circuitry may further control the display device to display, based on the determined discount, an incentive including a final trip cost associated the trip plan.

According to another embodiment of the disclosure, a method to promote rider safety in a shared mobility space is provided. The method may include receiving a trip plan associated with a user identifier. The trip plan may include a current travel route of a micro-mobility vehicle associated with a shared mobility service. The method may further include determining incident information associated with a number of past traffic incidents on at least one portion of the current travel route and controlling a display device associated with the micro-mobility vehicle, to display an option to replace the current travel route with a safer alternate route. The option to replace the current travel route may be displayed based on the determined incident information. The method may further include receiving a user input that may include a selection of the displayed option and determining a discount applicable on an initial trip cost associated with the trip plan based on the received user input. The method may further include controlling the display device to display, based on the determined discount, an incentive that may include a final trip cost associated the trip plan.

According to an embodiment of the disclosure, a non-transitory computer-readable medium is provided. The non-transitory computer-readable medium may store thereon, computer-executable instructions which, when executed by an electronic apparatus, cause the electronic apparatus to execute operations. The operations may include receiving a trip plan associated with a user identifier. The trip plan may include a current travel route of a micro-mobility vehicle associated with a shared mobility service. The operations may further include determining incident information associated with a number of past traffic incidents on at least one portion of the current travel route and controlling a display device associated with the micro-mobility vehicle, to display an option to replace the current travel route with a safer alternate route. The option to replace the current travel route may be displayed based on the determined incident information. The operations may further include receiving a user input that may include a selection of the displayed option and determining a discount applicable on an initial trip cost associated with the trip plan based on the received user input. The operations may further include controlling the display device to display, based on the determined discount, an incentive that may include a final trip cost associated the trip plan.

### BRIEF DESCRIPTION OF THE DRAWINGS

FIG. 1 is a block diagram that illustrates an exemplary network environment promoting rider safety in a shared mobility space, in accordance with an embodiment of the disclosure.

FIG. 2 is a block diagram of an electronic apparatus promoting rider safety in a shared mobility space, in accordance with an embodiment of the disclosure.

FIG. 3 is a process flow diagram that illustrates exemplary operations to promote rider safety in a shared mobility space, in accordance with an embodiment of the disclosure.

FIG. 4 is a sequence diagram that illustrates exemplary operations for offering a discount on a trip cost of based on whether a user selects a safe alternate route for a trip plan, in accordance with an embodiment of the disclosure.

FIG. 5 is a sequence diagram that illustrates exemplary operations for a speed control of a micro-mobility vehicle based on a preset speed limit, in accordance with an embodiment of the disclosure.

FIG. 6 is a sequence diagram that illustrates exemplary operations for a speed control of the micro-mobility vehicle based on user's riding experience with the micro-mobility vehicle, in accordance with an embodiment of the disclosure.

FIG. 7 is a sequence diagram that illustrates exemplary operations for a speed control of the micro-mobility vehicle based on a vehicle state, in accordance with an embodiment of the disclosure.

FIG. 8 is a sequence diagram that illustrates exemplary operations for providing additional incentives or penalties on a final trip cost based on a user behavior during a trip, in accordance with an embodiment of the disclosure.

FIG. 9 is an exemplary scenario diagram that illustrates exemplary operations to promote rider safety, in accordance with an embodiment of the disclosure.

FIG. 10 is a diagram of an exemplary micro-mobility vehicle, in accordance with an embodiment of the disclosure.

FIG. 11 is a flowchart that illustrates exemplary operations to promote rider safety in a shared mobility space, in accordance with an embodiment of the disclosure.

The foregoing summary, as well as the following detailed description of the present disclosure, is better understood when read in conjunction with the appended drawings. For the purpose of illustrating the present disclosure, exemplary constructions of the preferred embodiment are shown in the drawings. However, the present disclosure is not limited to the specific methods and structures disclosed herein. The description of a method step or a structure referenced by a numeral in a drawing is applicable to the description of that method step or structure shown by that same numeral in any subsequent drawing herein.

### DETAILED DESCRIPTION

The following described implementations may be found in the disclosed electronic apparatus. Exemplary aspects of the disclosure may provide an electronic apparatus that may receive a trip plan associated with a user identifier. The trip plan may include a current travel route of a micro-mobility vehicle (such as an electric scooter) associated with a shared mobility service (such as a scooter renting service). Upon receiving the current travel route, the electronic apparatus may determine incident information associated with a number of past traffic incidents on at least one portion of the current travel route. Based on the determined incident information, the electronic apparatus may further determine a safer alternate route and display the safer alternate route to the rider. In case the rider selects the safer alternate route, the electronic apparatus may further determine a discount applicable on an initial trip cost associated with the trip plan. Based on the discount, the electronic apparatus may share an incentive which includes a final trip cost associated with the trip plan. A discounted trip cost may incentivize the rider to select the safer alternate route for an ongoing trip plan and even future trips, thereby improving the safety of the rider in the current and future trips.

In some instances, if the rider selects the safer alternate route with lesser traffic incidents as compared to the current travel route (which may have a higher number of traffic incidents), the likelihood that the micro-mobility vehicle may suffer any damage due traffic incidents may be reduced. Hence, a maintenance cost associated with a repair of the micro-mobility vehicle may also be reduced. As the traffic incidents on the safer alternate route are less as compared to that on the current travel route, there may be a chance of lesser traffic jam on the safer alternate route. In such a scenario, the safer alternate route may be considered as a faster route as compared to the current travel route. In some other instances, as more riders may be incentivized to select the safer alternate route, accidental or vehicle insurance costs associated with running the shared mobility service may go down.

Reference will now be made in detail to specific aspects or features, examples of which are illustrated in the accompanying drawings. Wherever possible, corresponding, or similar reference numbers will be used throughout the drawings to refer to the same or corresponding parts.

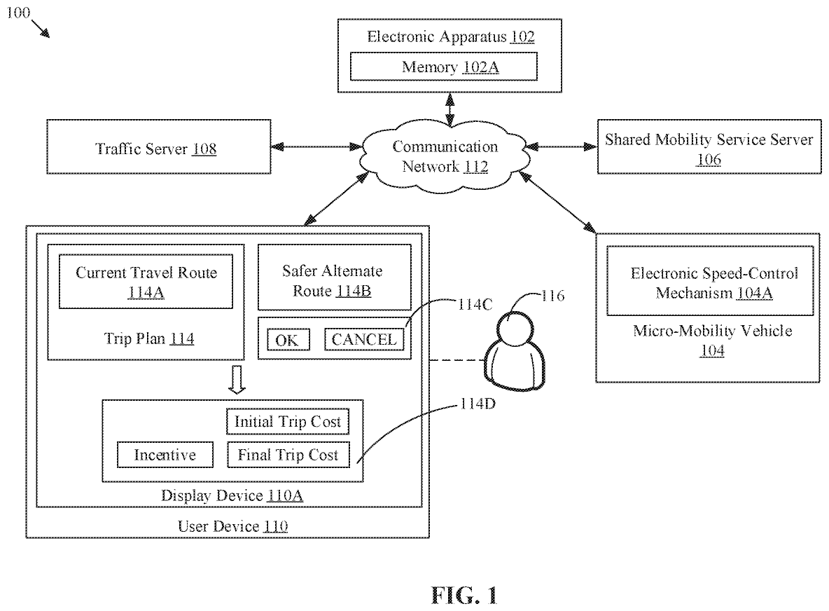

FIG. 1 is a block diagram that illustrates an exemplary network environment promoting rider safety in a shared mobility space, in accordance with an embodiment of the disclosure. There is shown a network environment 100 which includes an electronic apparatus 102, a micro-mobility vehicle 104, a shared mobility service server 106, a traffic server 108, and a user device 110. The electronic apparatus 102 may be configured to communicate with the micro-mobility vehicle 104, the shared mobility service server 106, the traffic server 108, or the user device 110, via a communication network 112.

The electronic apparatus 102 may include suitable logic, circuitry, interfaces, and/or code that may be configured receive a trip plan 114 associated with a user identifier. The user identifier may be associated with a user 116 of the shared mobility service. The user 116 may be herein referred to as a rider of the micro-mobility vehicle 104. The rider may be registered with the shared mobility service as a customer who may be assigned a unique identifier or a user identifier (such as a username, a secure key, or an alphanumeric code).

The electronic apparatus 102 may communicate with the user device 110 to display information associated with a safety of the rider. For example, such information may include an incentive to select a safer alternate route 114B in case a current travel route 114A is determined as unsafe for the rider. Additionally, or alternatively, the electronic apparatus 102 may control a speed of the micro-mobility vehicle 104 based on a state (stable or unstable) of the micro-mobility vehicle 104, a duration of user riding experience with the micro-mobility vehicle 104, and/or a combination thereof.

In an embodiment, the electronic apparatus 102 may be a server, such as a cloud server, which may be utilized to execute various operations through web applications, cloud applications, HTTP requests, repository operations, file transfer, and the like. Examples of the electronic apparatus 102 may include, but are not limited to, an event server, a database server, a file server, a web server, a media server, a content server, an application server, a mainframe server, or a combination thereof. In one or more embodiments, the electronic apparatus 102 may be implemented as a plurality of distributed cloud-based resources.

In an embodiment, the electronic apparatus 102 may further include a memory 102A. The memory 102A may include suitable logic, circuitry, interfaces, and/or code that may be configured to store program instructions that may be executable by the electronic apparatus 102. The memory 102A may be configured to also store the trip plan 114 associated with the user identifier. The memory 102A may be configured to also store information, such as the current travel route 114A associated with the trip plan 114, an initial trip cost associated with the current travel route 114A, incident information (e.g. an incident database) associated with the current travel route, the safer alternate route 1146, or discounts applicable on the initial trip cost.

In some embodiments, the memory 102A may be configured to store speed information (such as a current speed) of the micro-mobility vehicle 104, user information (such as a username, or a travel history) related to the user identifier, a number of past traffic incidents, and vehicle information (such as a state of vehicle) associated with the micro-mobility vehicle 104. Examples of implementation of the memory 102A may include, but are not limited to, Random Access Memory (RAM), Read Only Memory (ROM), Hard Disk Drive (HDD), a Solid-State Drive (SSD), a CPU cache, and/or a Secure Digital (SD) card.

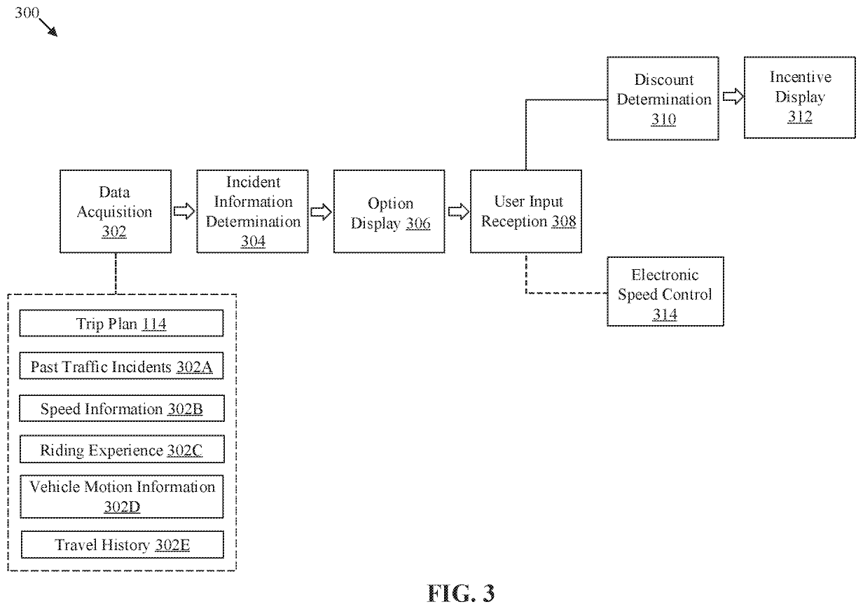

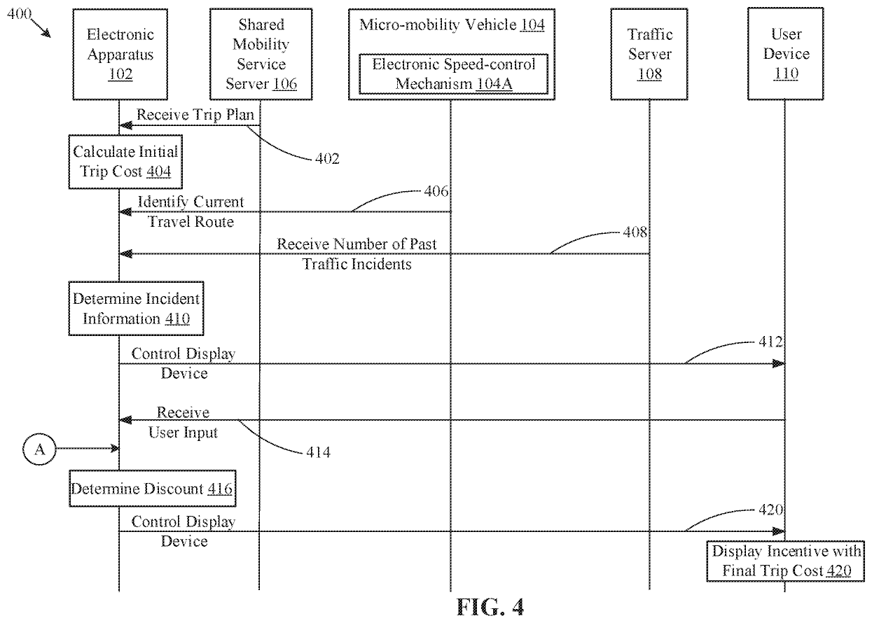

The micro-mobility vehicle 104 may include suitable propulsion systems, drive systems, or power sources to operate according to the trip plan 114. The micro-mobility vehicle 104 may be driven by a human rider (such as the user 116) through suitable control mechanisms. The micro-mobility vehicle 104 may include embedded devices with suitable logic, circuitry, interfaces, and/or code that may be configured to communicate with the electronic apparatus 102, the shared mobility service server 106, or a combination of both, via the communication network 112. Detailed operations of the micro-mobility vehicle 104 are described, for example in FIG. 3, and FIGS. 4, 5, 6, 7, and 8.

In an embodiment, the micro-mobility vehicle 104 may be an electric vehicle. Examples of the electric vehicle may include, but are not limited to, an electric scooter, an electric skateboard, electric-bike (e-bike), a bicycle, or an electric scooter-board. In another embodiment, the micro-mobility vehicle 104 may be a non-autonomous, a semi-autonomous, or an autonomous vehicle. Examples of the micro-mobility vehicle 104 may include, but are not limited to, an electric vehicle, a hybrid vehicle, and/or a vehicle that uses a combination of one or more distinct renewable and non-renewable power sources. The micro-mobility vehicle 104 that uses renewable and non-renewable power sources may include a fossil fuel-based vehicle, an electric propulsion-based vehicle, a hydrogen fuel-based vehicle, a solar-powered vehicle, and/or a vehicle powered by other forms of alternative energy sources. The micro-mobility vehicle 104 may be used, for example, in indoor or outdoor environments, at public places (such as within airport terminals) or inside private campuses.

In an embodiment, the micro-mobility vehicle 104 may include an electronic speed-control mechanism 104A. The electronic speed-control mechanism 104A may include suitable logic, circuitry, interfaces, and/or code that may be configured to control a speed of the micro-mobility vehicle 104. In an embodiment, the electronic speed-control mechanism 104A may be configured to control the speed of the micro-mobility vehicle 104 based on a user input to the electronic speed-control mechanism 104A.

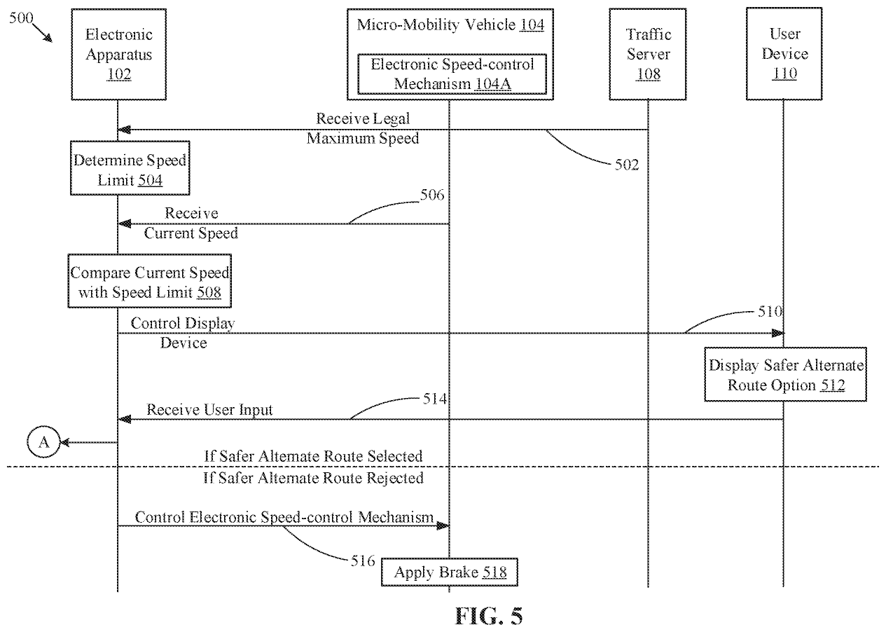

In an embodiment, the electronic speed-control mechanism 104A may be configured to control the speed of the micro-mobility vehicle 104 based on control instructions of the electronic apparatus 102. Details of such speed control are further described, for example in FIG. 3, and FIGS. 5, 6, and 7. Examples of the electronic speed-control mechanism 104A may include, but are not limited to, an electric motor with an electronic speed controller (ESC), a brushed electronic speed-control mechanism or a brushless electronic speed-control mechanism.

The shared mobility service server 106 may include suitable logic, circuitry, interfaces, and/or code that may be configured to communicate user information associated with the user identifier to the electronic apparatus 102, via the communication network 112. The user information may include, for example, trip details, a trip cost, a travel route, a total riding experience with the micro-mobility vehicle 104, and the like. In an embodiment, the shared mobility service server 106 may be managed by the same entity that manages the electronic apparatus 102 to provide the shared mobility service. In another embodiment, the shared mobility service server 106 may be managed by an entity which may be different from the one that provides the shared mobility service.

In an embodiment, the shared mobility service server 106 may be a cloud server, which may be utilized to execute various operations through web applications, cloud applications, HTTP requests, repository operations, file transfer, and the like. Examples of the shared mobility service server 106 may include, but are not limited to, an event server, a database server, a file server, a web server, a media server, a content server, an application server, a mainframe server, or a combination thereof. In one or more embodiments, the shared mobility service server 106 may be implemented as a plurality of distributed cloud-based resources.

In an embodiment, the shared mobility service server 106 may be configured to communicate with at least one of the electronic apparatus 102, the micro-mobility vehicle 104, or the user device 110, via the communication network 112 to store the user information associated with the user identifier. In another embodiment, the shared mobility service server 106 may be configured to communicate with the traffic server 108, via the communication network 112 to receive traffic information for various routes.

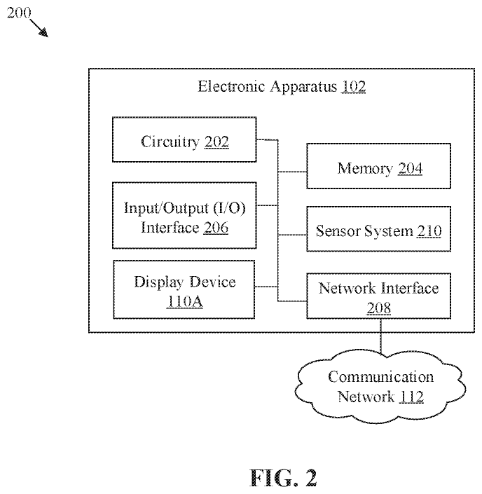

The traffic server 108 may include suitable logic, circuitry, interfaces, and/or code that may be configured to communicate traffic information with the electronic apparatus 102, via the communication network 112. In an embodiment, the traffic server 108 may collect traffic information from vehicles or different traffic data aggregators. The collected traffic information may be associated with locations (e.g., roads) of the current travel route 114A of the trip plan 114. The traffic server 108 may transmit the collected traffic information to the electronic apparatus 102. In one embodiment, the traffic information may be collected from sensors installed at specific locations on a travel route (such as near traffic signals, junctions, turns, highway sections, or roads) by government transportation agencies or private companies that specialize in compiling traffic data. In another embodiment, the traffic information may be collected based on sensor data from the user device 110 and/or other user devices in vicinity of the user device 110. For example, the sensor data may include a time-series of GPS location values of the user device 110 and/or other user devices in vicinity of the user device 110. Such values may be used to identify a congestion of vehicles at a specific location. The congestion of vehicles may be collected as a datapoint of the traffic information. The traffic information may also include datapoints related to a number of traffic incidents, such as, but not limited to, traffic jams, accidents, barricading of roads, a roadblock due to protest or a road blockade, slowdowns, or speed traps. Details of such sensor data is further described, for example in FIG. 2.

In an embodiment, the traffic server 108 may be a cloud server, which may be utilized to execute various operations through web applications, cloud applications, HTTP requests, repository operations, file transfer, and the like. Examples of the traffic server 108 may include, but are not limited to, an event server, a database server, a file server, a web server, a media server, a content server, an application server, a mainframe server, or a combination thereof. In one or more embodiments, the traffic server 108 may be implemented as a plurality of distributed cloud-based resources. In a specific embodiment, the traffic server 108 may be configured to communicate with at least one of the electronic apparatus 102, the micro-mobility vehicle 104, or the shared mobility service server 106, via the communication network 112 to exchange the traffic information. In an embodiment, the traffic server 108 may be configured to communicate with the user device 110, via the communication network 112 to display traffic information.

The user device 110 may include suitable logic, circuitry, and interfaces that may be configured to execute one or more software applications associated with the shared mobility service. A software application on the user device 110 may include an electronic user interface to display information associated with the trip plan 114 and/or receive a user input. The user device 110 may be implemented as a mobile device, which may be configured to receive a user input. Examples of the mobile device may include, but are not limited to, a wearable electronic device, a smartphone, a cellular phone, a mobile phone, a gaming device, and/or a consumer electronic (CE) device. The user device 110 may include the display device 110A to receive the user input and display information associated with the one or more software applications.

The display device 110A may include suitable logic, circuitry, and interfaces that may be configured to display the information associated with the trip plan 114 on the electronic user interface. In an embodiment, the display device 110A may be configured to also display the traffic information associated with the trip plan 114. The display device 110A may be a touch screen which may enable the rider to provide a user-input via the display device 110A. The display device 110A may be realized through several known technologies such as, but not limited to, at least one of a Liquid Crystal Display (LCD) display, a Light Emitting Diode (LED) display, a plasma display, or an Organic LED (OLED) display technology, or other display devices. In accordance with an embodiment, the display device 110A may refer to a display screen of a head mounted device (HMD), a smart-glass device, a see-through display, a projection-based display, an electro-chromic display, or a transparent display.

In an embodiment, the display device 110A may be integrally located within the electronic apparatus 102. In another embodiment, the display device 110A (such as a display screen) may be integrally assembled with the user device 110 (such as a mobile device). In another embodiment, the display device 110A (such as a head-mounted device) may be separate from the electronic apparatus 102 and may communicate with the electronic apparatus 102, via the communication network 112.

The communication network 112 may include a communication medium through which the electronic apparatus 102, the micro-mobility vehicle 104, the shared mobility service server 106, the traffic server 108, and the user device 110 may communicate with each other. The communication network 112 may be one of a wired connection or a wireless connection. Examples of the communication network 112 may include, but are not limited to, the Internet, a cloud network, a Wireless Fidelity (Wi-Fi) network, a Personal Area Network (PAN), a Local Area Network (LAN), or a Metropolitan Area Network (MAN). Various devices in the network environment 100 may be configured to connect to the communication network 112 in accordance with various wired and wireless communication protocols. Examples of such wired and wireless communication protocols may include, but are not limited to, at least one of a Transmission Control Protocol and Internet Protocol (TCP/IP), User Datagram Protocol (UDP), Hypertext Transfer Protocol (HTTP), File Transfer Protocol (FTP), Zig Bee, EDGE, IEEE 802.11, light fidelity (Li-Fi), 802.16, IEEE 802.11s, IEEE 802.11g, multi-hop communication, wireless access point (AP), device to device communication, cellular communication protocols, and Bluetooth (BT) communication protocols. In an embodiment, the communication network 112 may transfer the trip plan 114 associated with the user identifier between the electronic apparatus 102 and the user device 110.

In operation, the electronic apparatus 102 may receive, through the communication network 112, the trip plan 114 associated with the user identifier. The trip plan 114 may include the current travel route 114A of the micro-mobility vehicle 104 associated with the shared mobility service. For example, the shared mobility service may offer a dock-less e-scooter which the user 116 may locate on a map displayed in a software application on the user device 110). The user may move to the location of the e-scooter and may unlock the e-scooter via the software application to start a ride.

The electronic apparatus 102 may determine, from the traffic server 108, incident information associated with a number of past traffic incidents on at least one portion of the current travel route 114A. Based on the determined incident information, the electronic apparatus 102 may control the display device 110A to display an option to replace the current travel route 114A with the safer alternate route 114B.

By way of example, and not limitation, the option to replace the current travel route 114A with the safer alternate route 114B may be displayed on a selection interface 114C. The selection interface 114C may include a first option (such as “OKAY”) and a second option (such as “CANCEL”). If the first option is selected, the safer alternate route 114B may be selected to replace the current travel route 114A. Similarly, if the second option is selected, the option to replace the current travel route 114A with the safer alternate route 114B may be rejected. In FIG. 1, options, such as “OKAY” or “CANCEL” are merely provided as an example and should not be construed as limiting for the disclosure.

By way of another example, and not limitation, the option to replace the current travel route 114A with the safer alternate route 114B may be displayed as one of a notification with accept and reject buttons, a popup-message with accept and reject buttons, a dialog box with accept and reject buttons, a callout window with accept and reject buttons, or a notification enabled with voice-based with accept and reject commands.

The safer alternate route 114B may be an alternative to the current travel route 114A of the micro-mobility vehicle 104 and may be displayed on the display device 110A. Also, the safer alternate route 114B may be associated with a second number of past traffic incidents which may be less (or substantially less) than a first number of past traffic incidents associated with the current travel route 114A. In an embodiment, the safer alternate route 114B may be a longer route in terms of a route length or a trip duration as compared to the current travel route 114A. In another embodiment, the safer alternate route 114B may be a shorter route in terms a route length or a trip duration as compared to the current travel route 114A.

The electronic apparatus 102 may receive, via the selection interface 114C, a user input that may include a selection of the displayed option (i.e. a selection of “OKAY”) to replace the current travel route 114A with the safer alternate route 114B. After the selection, the electronic apparatus 102 may determine a discount applicable on an initial trip cost associated with the trip plan 114 based on the received user input. In an embodiment, the discount may be determined further based on a difference (or a percentage difference) between a length of the current travel route 114A and a length of the safer alternate route 114B. For example, if the length of the safer alternate route 114B is 10% more than the length of the current travel route 114A, then a discount of 10% may be determined to be applicable on the initial trip cost.

The electronic apparatus 102 may control the display device 110A to display an incentive which includes the final trip cost associated the trip plan 114. For example, the display device 110A may be controlled to display an output interface 114D which may show the initial trip cost associated with the current travel route 114A and the final trip cost associated with the safer alternate route 1148. Also, in some cases, the output interface 114D may show potential savings in terms of the determined discount or in terms of cost savings (such as United States Dollars (USD)). The incentive shown on the display device 110A may reward the rider on selecting the safer alternate route 1148 by applying a discount on the initial trip cost, even if the safer alternate route 1148 is longer than the current travel route 114A. With such a reward, the rider may be encouraged and incentivized to opt for safer alternate routes in subsequent trip plans, and such an encouragement may promote the safety of the rider during such trips.

For example, in case the rider selects the safer alternate route 114B with lesser traffic incidents (as compared to the current travel route 114A that has the high number of traffic incidents), a safer trip to the destination point is ensured, and any likelihood of damage to the micro-mobility vehicle 104 due to traffic incidents may be minimized. Hence, the electronic apparatus 102 in accordance with the present embodiment promotes safety and reduces maintenance cost of the micro-mobility vehicle 104.

Modifications, additions, or omissions may be made to FIG. 1 without departing from the scope of the present disclosure. For example, the network environment 100 may include more or fewer elements than those illustrated and described in the present disclosure. For example, in some embodiments, the functionality of the shared mobility service server 106 and the traffic server 108 may be incorporated at least partially or in its entirety in the electronic apparatus 102, without a deviation from the scope of the disclosure.

FIG. 2 is a block diagram of an electronic apparatus promoting rider safety in a shared mobility space, in accordance with an embodiment of the disclosure. FIG. 2 is explained in conjunction with elements from FIG. 1. With reference to FIG. 2, there is shown a block diagram 200 of the electronic apparatus 102. In FIG. 1, the user device 110 is shown to be separate from the electronic apparatus 102; however, the disclosure may not be so limited. For example, in FIG. 2, the functionality of the user device 110 may be incorporated in its entirety or at least partially in the electronic apparatus 102. In such a case, the display device 110A may be integrated with the electronic apparatus 102, without a deviation from scope of the disclosure.

In FIG. 2, the electronic apparatus 102 may be implemented as a mobile device that may be associated with the rider. Examples of the mobile device may include, but are not limited to, a wearable electronic device (such as a smart watch or a smart glass), a head-mounted display (such a helmet-mounted display, an audio headset, or an Augmented Reality (AR) headset), a smartphone, a cellular phone, a mobile phone, a gaming device, and/or a consumer electronic (CE) device.

In an embodiment, one or more functionalities of the shared mobility service server 106 may be incorporated in the electronic apparatus 102 at least partially or in its entirety, without a deviation from the scope of the present disclosure. In another embodiment, the electronic apparatus 102 may be implemented as a server to track and manage trip plans associated with various micro-mobility vehicles registered with the shared mobility service.

The electronic apparatus 102 may include circuitry 202, a memory 204, a I/O interface 206, and a network interface 208. In at least one embodiment, the electronic apparatus 102 may also include a sensor system 210. The circuitry 202 may be coupled to the memory 204, the I/O interface 206, the network interface 208, and the sensor system 210.

The circuitry 202 may include suitable logic, circuitry, and/or interfaces that may be configured to execute program instructions associated with different operations to be executed by the electronic apparatus 102. The circuitry 202 may include any suitable special-purpose or general-purpose computer, computing entity, or processing device including various computer hardware or software modules and may be configured to execute instructions stored on any applicable computer-readable storage media (for example, the memory 204).

The circuitry 202 may be implemented based on a number of processor technologies known in the art. For example, the circuitry 202 may include a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or to process data. The circuitry 202 may include any number of processors configured to, individually or collectively, perform any number of operations of the electronic apparatus 102, as described in the present disclosure. Examples of the circuitry 202 may include a Central Processing Unit (CPU), a Graphical Processing Unit (GPU), an x86-based processor, an x64-based processor, a Reduced Instruction Set Computing (RISC) processor, a Complex Instruction Set Computing (CISC) processor, and/or other hardware processors.

The memory 204 may be an exemplary implementation of the memory 102A of FIG. 1. The memory 204 may include suitable logic, circuitry, interfaces, and/or code that may be configured to store the program instructions executable by the circuitry 202. The memory 204 may be configured to also store the trip plan 114 associated with the user identifier, the current travel route 114A, the initial trip cost, the incident information, the safer alternate route 114B, the discount on the initial trip cost, and the final trip cost.

The memory 204 may be configured to also store speed information (such as a current speed) of the micro-mobility vehicle 104, user information (such as a username, travel history, and the like) related to the user identifier, and vehicle information (such as a state of vehicle) associated with the micro-mobility vehicle 104. Examples of implementation of the memory 204 may include, but are not limited to, Random Access Memory (RAM), Read Only Memory (ROM), Hard Disk Drive (HDD), a Solid-State Drive (SSD), a CPU cache, and/or a Secure Digital (SD) card.

The I/O interface 206 may include suitable logic, circuitry, interfaces, and/or code that may be configured to may receive user inputs and generate outputs in response to the received user inputs. The I/O interface 206 may receive the trip plan 114 associated with the user identifier based on a user input. The I/O interface 206 may be integrally coupled with the electronic apparatus 102, through which such a user input may be received from the rider of the micro-mobility vehicle 104. The I/O interface 206 may include various input and output devices which may be configured to communicate with the circuitry 202. Examples of the I/O interface 206 may include, but are not limited to, a touch screen, a keyboard, a mouse, a joystick, a microphone, a display device, a speaker, and/or an image sensor.

The network interface 208 may include suitable logic, circuitry, and interfaces that may be configured to facilitate communication between the circuitry 202 and the communication network 112. The network interface 208 may be implemented by use of various known technologies to support wired or wireless communication of the electronic apparatus 102 with the communication network 112. The network interface 208 may include, but is not limited to, an antenna, a radio frequency (RF) transceiver, one or more amplifiers, a tuner, one or more oscillators, a digital signal processor, a coder-decoder (CODEC) chipset, a subscriber identity module (SIM) card, or a local buffer circuitry. The network interface 208 may be configured to communicate via wireless communication with networks, such as the Internet, an Intranet or a wireless network, such as a cellular telephone network, a wireless local area network (LAN), and a metropolitan area network (MAN). The wireless communication may be configured to use one or more of a plurality of communication standards, protocols and technologies, such as Global System for Mobile Communications (GSM), Enhanced Data GSM Environment (EDGE), wideband code division multiple access (W-CDMA), Long Term Evolution (LTE), code division multiple access (CDMA), time division multiple access (TDMA), Bluetooth, Wireless Fidelity (Wi-Fi) (such as IEEE 802.11a, IEEE 802.11b, IEEE 802.11g or IEEE 802.11n), voice over Internet Protocol (VoIP), light fidelity (Li-Fi), Worldwide Interoperability for Microwave Access (Wi-MAX), a protocol for email, instant messaging, and a Short Message Service (SMS).

The sensor system 210 may include suitable logic, circuitry, and interfaces that may be configured to determine traffic information (such as a number of current or past traffic incidents) on the current travel route 114A. Additionally, or alternatively, the sensor system 210 may acquire a current speed and a current position of the micro-mobility vehicle 104. In an embodiment, the sensor system 210 may include at least one of: a location sensor, a speed sensor, or an image sensor to acquire the current speed and the current position of the micro-mobility vehicle 104.

The location sensor may include suitable logic, circuitry, and/or interfaces that may be configured to determine a current geo-location of the electronic apparatus 102 on the current travel route 114A. The electronic apparatus 102 may identify the traffic information (such as a number of current or past traffic incidents) associated with the determined geo-location (or a geo-fence around the determined geo-location). In an embodiment, the location sensor may include a Global Navigation Satellite System (GNSS)-based sensor. In another embodiment, the location sensor may include one or more of an inertial measurement unit, a mobile networking device (e.g., with a Subscriber Identity Module (SIM)) to connect to a mobile positioning network (such as mobile Long-tern Evolution (LTE) network), an accelerometer, a gyroscope, or a combination thereof.

The speed sensor may include suitable logic, circuitry, interfaces, and/or code that may estimate a current speed of the electronic apparatus 102 on the current travel route 114A. If the electronic apparatus 102 is attached to the micro-mobility vehicle 104 or is carried by the rider of the micro-mobility vehicle 104, then the current speed of the electronic apparatus 102 may be referred to as the speed of the micro-mobility vehicle 104. The current speed may be determined based on a rate of change of the geo-location of the electronic apparatus 102. Based on the determined current speed on the current travel route 114A and the incident information, the electronic apparatus 102 may be configured to determine whether to display an option to replace the current travel route 114A with the safer alternate route 114B. Examples of the speed sensor may include, but are not limited to, Hall effect sensors, variable reluctance speed sensors, Radio Frequency (RF) speed sensors, Amplified (Active) speed sensors, Light Detection and Ranging (LiDAR) speed sensors, accelerometer-based speed sensors, and optical speed sensors.

The image sensor may include suitable logic, circuitry, and interfaces that may be configured to capture an image or multiple images of vehicles in vicinity of the micro-mobility vehicle 104 on the current travel route 114A. Based on the captured image or multiple images, the electronic apparatus 102 may be configured to identify the traffic information, such as a number of traffic incidents on the current travel route 114A. Examples of the image sensor may include, but are not limited to, a CCD sensor or a CMOS sensor. The image sensor may be used in imaging devices such as a camera, a wide-angle camera, an action camera, a closed-circuit television (CCTV) camera, a camcorder, a digital camera, camera phones, a time-of-flight camera (ToF camera), a night-vision camera, and/or other image capture devices.

In operation, the circuitry 202 of the electronic apparatus 102 (such as the mobile device associated with the rider) may receive, through a user input or via the communication network 112, the trip plan 114 associated with the user identifier. The trip plan 114 may include the current travel route 114A of the micro-mobility vehicle 104 associated with the shared mobility service. The circuitry 202 may further receive, from the traffic server 108, a number of past traffic incidents on at least one portion of the current travel route 114A. Based on the number of part traffic incidents, the circuitry 202 may determine incident information. The determined incident information may include details of the number of part traffic incidents. For example, such details may include a time and day of each incident, an exact or an approximate location of each incident, a speed of vehicle at the time of each incident, and the like.

Based on the determined incident information, the circuitry 202 may be configured to control the display device 110A to display an option (such as the option “OKAY” of the selection interface 114C of FIG. 1) to replace the current travel route 114A with the safer alternate route 114B. The circuitry 202 may further receive the user input that may include a selection of the displayed option (such as “OKAY”). The circuitry 202 may determine a discount applicable on the initial trip cost associated with the trip plan 114 based on the received user input. The circuitry 202 may further control the display device 110A to display an incentive which includes the final trip cost associated the trip plan 114. The final trip cost may be discounted as compared to the initial trip cost to reward the rider on selecting the safer alternate route 114B. An example of the displayed incentive is shown on the output interface 114D of FIG. 1.

In FIG. 2, it is shown that the electronic apparatus 102 includes the display device 110A, the circuitry 202, the memory 204, the I/O interface 206, the sensor system 210, and the network interface 208; however, the disclosure may not be limiting and the electronic apparatus 102 may include more or less components to perform the same or other functions of the electronic apparatus 102. Details of the other functions and the components have been omitted from the disclosure for the sake of brevity.

The functions or operations executed by the electronic apparatus 102, as described in FIG. 1, may be performed by the circuitry 202. Operations executed by the circuitry 202 are described further, for example, in the FIG. 3, and FIGS. 4, 5, 6, 7, and 8.

FIG. 3 is a process flow diagram that illustrates exemplary operations to promote rider safety in a shared mobility space, in accordance with an embodiment of the disclosure. FIG. 3 is explained in conjunction with elements from FIG. 1 and FIG. 2. With reference to FIG. 3, there is shown a process flow diagram 300. The exemplary operations of the process flow diagram 300 may start from 302 and may be performed by any computing system or device, such as by the electronic apparatus 102 of FIG. 1 or FIG. 2.

At 302, data acquisition may be performed. In an embodiment, the electronic apparatus 102 may be configured to receive data associated with the user identifier and/or the micro-mobility vehicle 104. The acquired data may be stored in the memory 204 of the electronic apparatus 102. The acquired data may include, for example, the trip plan 114 associated with the user identifier, past traffic incidents 302A that may have occurred on at least one portion of the current travel route 114A, speed information 302B associated with the micro-mobility vehicle 104, a riding experience 302C of the rider (associated with the user identifier), vehicle motion information 302D associated with the micro-mobility vehicle 104, or a travel history 302E associated with the user identifier. Operations of data acquisition are further described, for example, in the FIGS. 4, 5, 6, 7, and 8. In an embodiment, the sensor system 210 may be configured to acquire the data. In another embodiment, the data may be acquired from at least one of: the micro-mobility vehicle 104, the shared mobility service server 106, or the traffic server 108.

At 304, incident information may be determined. In an embodiment, the electronic apparatus 102 may be configured to determine the incident information associated with a number of past traffic incidents on at least one portion of the current travel route 114A. For example, the electronic apparatus 102 may receive incident information from the traffic server 108.

In an embodiment, the electronic apparatus 102 may receive information of a day of week and a travel period associated with the trip plan 114. The electronic apparatus 102 may select, from the memory 102A (such as an incident database) or the memory 204, a number of past traffic incidents which may have occurred in the past on the day of week and within the travel period. The determined incident information may be associated with the selected number of past traffic incidents. Operations for the determination of the incident information are further described, for example, in the FIGS. 4 and 5. In another embodiment, the incident information may be acquired from at least one of: the micro-mobility vehicle 104 or the shared mobility service server 106.

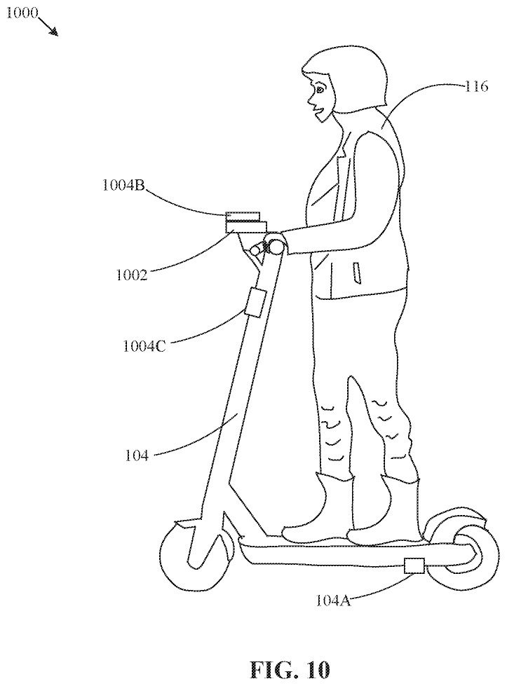

At 306, an option to replace the current travel route 114A with the safer alternate route 114B may be displayed. In an embodiment, the electronic apparatus 102 may be configured to display the option to replace the current travel route 114A with the safer alternate route 1146 on the display device 110A. The option may be displayed based on the determined incident information. The safer alternate route 114B may be associated with a second number of past traffic incidents which may be less than a first number of past traffic incidents associated with the current travel route 114A. Operations associated with the display of the option are further described, for example, in the FIG. 4. In another embodiment, along with the option, the safer alternate route 114B may also be displayed on the display device 110A. For example, the display device 110A may be an in-vehicle display device (as shown, for example, in FIG. 10) of the micro-mobility vehicle 104.

At 308, a user input may be received. In an embodiment, the electronic apparatus 102 may be configured to receive a user input which includes a selection of the displayed option. For example, the user input may be received from the display device 110A. Operations of user input reception are further described, for example, in the FIG. 4.

In an embodiment, the user input may be received via the I/O Interface 206 of the electronic apparatus 102. In another embodiment, the user input may be received from an I/O interface associated with the micro-mobility vehicle 104. The I/O interface associated with the micro-mobility vehicle 104 may perform same functions as the I/O Interface 206 associated with the electronic apparatus 102. If the user input relates to a selection of the safer alternate route 1146, control may pass to 310. Whereas, if the user input relates to a rejection of the safer alternate route 1146, control may pass to 314.

At 310, a discount may be determined on the initial trip cost. In an embodiment, the electronic apparatus 102 may be configured to determine the discount applicable on the initial trip cost associated with the trip plan 114. Such a discount may be determined based on the received user input. Operations associated with the determination of the discount are further described, for example, in the FIG. 4.

At 312, an incentive may be displayed. In an embodiment, the electronic apparatus 102 may be configured to control the display device 110A to display an incentive based on the determined discount. The incentive may include the final trip cost associated the trip plan 114. For example, the electronic apparatus 102 may calculate the final trip cost by subtracting the determined discount from the initial trip cost and may display the final trip cost on the display device 110A. Operations associated with the display of the incentive are further described, for example, in the FIG. 4. In another embodiment, the incentive may be displayed on an in-vehicle display system of the micro-mobility vehicle 104. In such a case, the display device 110A may be implemented as the in-vehicle display system.

At 314, an electronic speed control may be performed. In an embodiment, the electronic apparatus 102 may be configured to control the electronic speed-control mechanism 104A to electronically control the speed of the micro-mobility vehicle 104. Operations of the electronic speed control are further described, for example in the FIGS. 5, 6, and 7.

FIG. 4 is a sequence diagram that illustrates exemplary operations for offering a discount on a trip cost of based on whether a user selects a safe alternate route for a trip plan, in accordance with an embodiment of the disclosure. FIG. 4 is described in conjunction with FIGS. 1, 2, and 3. With reference to FIG. 4, there is shown a sequence flow diagram 400 of exemplary operations. The exemplary operations may start from 402 and may performed by any suitable computing system or device, such as by the electronic apparatus 102 of FIG. 1 or FIG. 2.

In FIG. 4A, the electronic apparatus 102 performs the exemplary operations from 402 to 420 to incentivize the user (such as the rider) for a selection of the safer alternate route 1146 (which may promote safety of the rider). It should be noted that the operations from 402 to 420 may be performed in real time or near real time due to a real-time connectivity between the electronic apparatus 102, the micro-mobility vehicle 104, the shared mobility service server 106, and the user device 110.

At 402, the trip plan 114 may be received. In an embodiment, the electronic apparatus 102 may receive the trip plan 114 from the shared mobility service server 106. For example, the shared mobility service server 106 may be configured to store user information associated with the user identifier. The user information may include the trip plan 114 and other information, such as a travel history of the user or a log of user experience (in hours) riding the micro-mobility vehicle 104. The trip plan 114 may include the current travel route 114A of the micro-mobility vehicle 104, a travel period (e.g. a trip start time and a trip end time), a direction of travel of the micro-mobility vehicle 104 on the current travel route 114A, a day of week, and the like. The current travel route 114A of the trip plan 114 may include a starting point and a destination point. Further details of trip plan 114 are described, for example in the FIG. 5. The shared mobility service server 106 may transmit the trip plan 114 to the electronic apparatus 102. In some embodiments, the electronic apparatus 102 may request the shared mobility service server 106 to share the trip plan 114 with the electronic apparatus 102.

At 404, the initial trip cost may be calculated. In an embodiment, the electronic apparatus 102 may be configured to calculate the initial trip cost associated with the current travel route 114A. The initial trip cost may be calculated based on a length of the current travel route 114A. For example, the initial trip cost may be more in case the current travel route 114A is long and less in case the current travel route 114A is short. In another embodiment, the initial trip cost may be calculated further based on current route conditions (such as traffic conditions, road conditions, and the like) associated with the current travel route 114A.

At 406, the current travel route 114A may be identified. In an embodiment, the electronic apparatus 102 may identify the current travel route 114A of the micro-mobility vehicle 104. As an example, the electronic apparatus 102 may communicate with the sensor system 210 to identify the current travel route 114A of the micro-mobility vehicle 104. As another example, the electronic apparatus 102 may communicate with an in-built sensor system (as shown, for example, in FIG. 10) of the micro-mobility vehicle 104 to identify the current travel route 114A. As another example, the current travel route 114A may be a part of the trip plan 114 stored on the electronic apparatus 102.

At 408, a number of past traffic incidents on at least one portion of the current travel route 114A may be received. In an embodiment, the electronic apparatus 102 may receive the number of past traffic incidents from the traffic server 108. For example, the number of traffic incidents may include traffic jams, accidents, disabled vehicles, slowdowns, speed traps, and the like.

At 410, incident information may be determined. In an embodiment, the electronic apparatus 102 may determine the incident information associated with the number of traffic incidents on at least one portion of the current travel route 114A. The electronic apparatus 102 may receive such incident information from the traffic server 108 and may generate an incident map for the current travel route 114A and a number of other travel routes. For example, the incident map may highlight locations on the current travel route 114A where the occurrence of traffic incidents is above a threshold number. The incident map may also include timing details of the occurrence of such traffic incidents, and the like. An example of the incident information (includes occurrence of traffic incidents in accordance with time periods (or travel periods), locations, and the days of week) is mentioned in Table 1, as follows:

TABLE 1
Example of incident information

| | | | Number of traffic |
|---|---|---|---|
| Time Periods | Location | Day | incidents |
| 7 A.M. to 10 A.M. | Area 1 | Weekday | High |
| 7 A.M. to 10 A.M. | Area 1 | Weekend | Low |
| 7 A.M. to 10 A.M. | Area 2 | Weekday | Low |
| 10 A.M. to 4 P.M. | Area 1 & Area 2 | Weekday | Low |
| 4 P.M. to 9 P.M. | Area 1 | Weekday | High |
| 4 P.M. to 9 P.M. | Area 2 | Weekday | Medium |

From Table 1, it may be observed that the number of traffic incidents vary based on the time period, the day of week, and the location. Data provided in Table 1 is merely an example and should not be construed as limiting for the present disclosure. As seen in Table 1, the occurrence of traffic incidents in the past may vary in accordance with time periods (or travel periods), locations, and the days of week and may be stored in an incident database of the memory 102A or the memory 204. In one case, from 7 A.M. to 10 A.M., Area 1 may have a high number of traffic incidents. However, Area 2 may have a low number of traffic incidents in the same time period (i.e., from 7 A.M. to 10 A.M.). In another case, from 10 A.M. to 4 P.M., both Area 1 and Area 2 may have a low number of traffic incidents. In another case, from 4 P.M. to 9 P.M., Area 1 may have a high number of traffic incidents. However, Area 2 may have a medium number of traffic incidents in the same time period (i.e., from 4 P.M. to 9 P.M.).

The traffic server 108 may also record a day of week of the traffic incident. For example, in case of a weekday, the traffic incidents may be high in a particular area (such as Area 1) in a particular time period (such as between 7 A.M. to 10 A.M.). However, in case of a weekend, the traffic incidents may be low in that particular area (such as Area 1) in the same time period (such as between 7 A.M. to 10 A.M.).

In an embodiment, the incident map may be generated based on road conditions (e.g., potholes, uneven road surfaces, and the like), which can be a likely cause of incidents on the current travel route 114A. In another embodiment, the incident map may be generated based on incident information associated with different user IDs (which may be recorded at specific time periods). An example of the incident information (includes occurrence of traffic incidents in accordance with different user IDs, a scooter speed, time periods (or travel periods), locations, and the days of week), is mentioned in Table 2, as follows:

TABLE 2
Example of incident information

| User | Scooter | Time | | | | Scooter |
|---|---|---|---|---|---|---|
| ID | ID | Periods | | Location | Day | Speed |
| User 1 | Scooter 1 | 7 | A.M. | Area 1 | Weekday | 20 mph |
| User 2 | Scooter 2 | 7:30 | A.M. | Area 1 | Weekend | 30 mph |
| User 3 | Scooter 3 | 8.30 | A.M. | Area 2 | Weekday | 25 mph |
| User 4 | Scooter 4 | 4 | P.M. | Area 2 | Weekday | 10 mph |

From Table 2, it may be observed that from 7 A.M. to 8.30 A.M., there are multiple incidents. For example, at 7 A.M., a user with user ID of “User 1” riding a scooter with scooter ID “Scooter 1” has met with a first traffic incident in Area 1 at 7:30 A.M., a user with user ID of “User 2” riding a scooter with scooter ID “Scooter 2” has met with a second traffic incident in Area 2 at 7 A.M, a user with user ID of “User 3” riding a scooter with scooter ID “Scooter 3” has met with a third traffic incident at 8:30 A.M at 4 P.M., and a user with user ID of “User 4” riding a scooter with scooter ID “Scooter 4” has met with a fourth traffic incident in Area 2 at 4 P.M. Such individual incidents are collated over time to generate the incident information for one or more travel routes. Data provided in Table 2 is merely an example and should not be construed as limiting for the present disclosure.

In an embodiment, the incident information may include multiple speed values of vehicles (such as e-scooters) and a correlation (i.e. insights in Table 3) of such values with the number of past traffic incidents. Examples of such insights for an example travel period and example speed values are mentioned, for example, in Table 3, as follows:

TABLE 3
Example insights for various speed values

| | Number of Past | | |
|---|---|---|---|
| Speed | Traffic Incidents | Day/Time | Insights |
| 5 mph | Low | Weekday/ | No issues |
| 10 mph | Medium | 7 A.M.- | 25% increase |
| 15 mph | High | 11 A.M. | 75% increase |

In Table 3, it may be observed that in case the speed associated with the micro-mobility vehicle 104 is 5 mph, the number of traffic incidents recorded at that speed on the current travel route 114A are low, and there are no issues observed. Further, in case the speed associated with the micro-mobility vehicle 104 is 10 mph, the number of traffic incidents recorded at that speed on the current travel route 114A is medium, and there is a 25% increase in issues on the current travel route 114A. Further, in case the speed associated with the micro-mobility vehicle 104 is 15 mph, the number of traffic incidents recorded at that speed on the current travel route 114A is high, and there is a 75% increase in issues on the current travel route 114A. Data provided in Table 3 is merely an example and should not be construed as limiting for the present disclosure.

At 412, an option to replace the current travel route 114A with the safer alternate route 1148 may be displayed. In an embodiment, the electronic apparatus 102 may control the display device 110A to display the option to replace the current travel route 114A with the safer alternate route 114B. For example, based on the determined incident information of Tables 1, 2, and 3, the electronic apparatus 102 may send control instructions to the display device 110A to display the safer alternate route 114B and the option to replace the current travel route 114A with the safer alternate route 114B.

At 414, a user input may be received. In an embodiment, the electronic apparatus 102 may receive the user input from the display device 110A. For example, the display device 110A may display the current travel route 114A, the safer alternate route 114B, and the selection interface 114C through which either of the current travel route 114A or the safer alternate route 114B may be selected. Based on a user selection via the selection interface 114C (such as the selection of the safer alternate route 114B or rejection of the safer alternate route 114B), the display device 110A may send the user input to the electronic apparatus 102.

At 416, a discount applicable on the initial trip cost may be determined based on the received user input. In an embodiment, the electronic apparatus 102 may determine the discount in case of the selection of the safer alternate route 114B. For example, in case the user input relates to the selection of the safer alternate route 114B over the current travel route 114A, the electronic apparatus 102 may calculate the discount applicable on the initial trip cost. In one embodiment, the discount may be calculated based on a comparison of time durations to reach the destination point from the starting point through the current travel route 114A and the safer alternate route 114B. In another embodiment, the discount may be calculated based on a comparison of distances to be travelled to reach the destination point from the starting point through the current travel route 114A and the safer alternate route 114B. Examples of different discounts in accordance with the time duration and the distance (or length) of the safer alternate route 114B are mentioned in Table 4, as follows:

TABLE 4
Examples of different discounts (in
percentage) on the initial trip cost

| | Safer | Safer | Safer | Safer |
|---|---|---|---|---|
| | Alternate | Alternate | Alternate | Alternate |
| Baseline | Route | Route | Route | Route |
| Initial | D + 10% | D + 25% | D + 50% | D + 100% |
| Distance | of D | of D | of D | of D |
| (D) | | | | |
| Initial | T + 10% | T + 25% | T + 50% | T + 100% |
| Time (T) | of T | of T | of T | of T |
| Initial Trip | C − 10% | C − 25% | C − 50% | C − 100% |
| Cost (C) | of C | of C | of C | of C |

From Table 4, it may be observed that the discount may vary based on the additional distance or travel time associated with the safer alternate route 1146 as compared to current travel route 114A. In the Table 4, in case a delay (such as, T+10%) is estimated to reach the destination point via the safer alternate route 1146 as compared to the estimated time duration (T) to reach the destination point via the current travel route 114A, the electronic apparatus 102 may calculate a discount of 10% on the initial trip cost associated with the trip plan 114. Similarly, in case a delay of T+25%, T+50%, or T+100% is estimated to reach the destination point via the safer alternate route 1146 as compared to the estimated time duration (T) to reach the destination point via the current travel route 114A, the electronic apparatus 102 may calculate a discount of 25%, 50%, or 100%, respectively on the initial trip cost based on the respective delay. The electronic apparatus 102 may calculate the final trip cost by subtracting the determined discount (in terms of discounted cost value) from the initial trip cost. From table 4, if the delay is 100% increase from the initial time (T), the ride may be offered as free with no trip cost (i.e., C—100% of C or a 100% discount on the initial trip cost) for the trip plan 114.

From Table 4, in case there is an increase in the distance (such as, D+10%) to reach the destination point via the safer alternate route 114B as compared to the distance (D) to reach the destination point via the current travel route 114A, the electronic apparatus 102 may calculate a discount of 10% on the initial trip cost of the trip plan 114. Similarly, in case there is an increase in the distance of D+25%, D+50%, or D+100% to reach the destination point via the safer alternate route 114B as compared to the distance (D) to reach the destination point via the current travel route 114A, the electronic apparatus 102 may calculate a discount of 25%, 50%, or 100%, respectively on the initial trip cost based on the respective increase in the distance.

For example, in case the initial trip cost is $10 for a ride of 10 miles on the current travel route 114A, and the safer alternate route 114B is 12.5 miles, the electronic apparatus 102 may calculate the final trip cost as $7.5 with a discount of 25%. Alternatively, in case the initial trip cost is $10 for a ride of 10 minutes on the current travel route 114A, and the safer alternate route 1146 takes 15 minutes, the electronic apparatus 102 may calculate the final trip cost as $5 with a discount of 50%. if the increased distance is 100% from the initial distance (D), the ride may be completely free with no trip cost (i.e., C—100% of C) incurred for the trip.

Data provided in Table 4 is merely an example and should not be construed as limiting for the present disclosure. One skilled in the art will understand that that the discounts mentioned in Table 4 are for representative purpose only, and such discounts may be changed based on business requirements or may be replaced with other forms of incentives. For example, the discount percentages may be changed based on an administrator input via the electronic apparatus 102 or via the shared mobility service server of FIG. 1.

At 418, the display device 110A may be controlled. In an embodiment, the electronic apparatus 102 may control the display device 110A to display the determined discount. For example, the electronic apparatus 102 may send the control instructions to the display device 110A to display the determined discount based on the received user input.

At 420, the incentive may be displayed with the final trip cost to encourage the rider to choose safer routes in future. In an embodiment, the display device 110A may display the incentive which includes the final trip cost associated with the trip plan 114. For example, the display device 110A may include the output interface 114D, which may be configured to display the incentive associated with the trip plan 114.

FIG. 5 is a sequence diagram that illustrates exemplary operations for a speed control of a micro-mobility vehicle based on a preset speed limit, in accordance with an embodiment of the disclosure. FIG. 5 is described in conjunction with FIGS. 1, 2, 3, and 4. With reference to FIG. 5, there is shown a sequence flow diagram 500 of exemplary operations. The exemplary operations may start from 502 and may performed by any suitable computing system or device, such as by the electronic apparatus 102 of FIG. 1 or FIG. 2. In FIG. 5, the exemplary operations from 502 to 518 relate to a speed control of the micro-mobility vehicle 104 based on a preset speed limit, such as a legal maximum speed of the current travel route 114A.

At 502, a legal maximum speed for a micro-mobility vehicle on the current travel route 114A may be received. In an embodiment, the electronic apparatus 102 may receive the legal maximum speed associated with the trip plan 114. For example, the traffic server 108 may store the legal maximum speed associated with the at least one portion of the current travel route 114A and may send the legal maximum speed to the electronic apparatus 102.

At 504, a speed limit may be determined. In an embodiment, the electronic apparatus 102 may determine the speed limit for the micro-mobility vehicle 104 on at least one portion of the current travel route 114A. The speed limit may be determined based on one or more of the determined incident information or the legal maximum speed for the at least one portion of the current travel route 114A. For example, from Table 3, the speed limit may be determined as 10 miles per hour between 7 A.M. to 11 A.M. on a weekday as the insight for the speed of 10 miles per hour indicates a 25% increase in the number of traffic incidents as compared to that for a speed of 5 miles per hour. In an embodiment, the speed limit may be determined to be less than the legal maximum speed.

At 506, a current speed may be received. In an embodiment, the electronic apparatus 102 may acquire the current speed associated with the micro-mobility vehicle 104. For example, the electronic apparatus 102 may receive the current speed from an in-built sensor system (as shown, for example, in FIG. 10) associated with the micro-mobility vehicle 104. The function of the in-built sensor system associated with the micro-mobility vehicle 104 may be same as that of the sensor system 210 of the electronic apparatus 102.

By way of example, and not limitation, from Table 3, in case the current speed associated with the micro-mobility vehicle 104 is 5 mph or less, the number of traffic incidents recorded at that speed on the current travel route 114A may be low, and there may be no safety concerns at such a speed. Hence, there may not be a need to change the current travel route 114A to the safer alternate route 114B. In case the current speed associated with the micro-mobility vehicle 104 is 10 mph, there is a 25% increase in the number of traffic incidents on the current travel route 114A as compared to that for a speed of 5 miles per hour. Thus, there may be a need to change the current travel route 114A to the safer alternate route 114B. In case the current speed associated with the micro-mobility vehicle 104 is 15 mph, there is a 75% increase in the number of traffic incidents as compared to that for a speed of 5 miles per hour on the current travel route 114A. Thus, there may be need to change the current travel route 114A to the safer alternate route 114B or to apply a suitable speed control to limit the movement of the micro-mobility vehicle 104 to a speed which may be less than or equal to the speed limit (determined at 504).

At 508, the current speed may be compared with the speed limit. In an embodiment, the electronic apparatus 102 may compare the received current speed associated with the micro-mobility vehicle 104 with the speed limit associated with the current travel route 114A. Based on the comparison, it may be determined whether the current speed is more than the speed limit. In case the current speed is more than the speed limit, control may pass to 510. Otherwise, the electronic apparatus 102 may continue to monitor the current speed of the micro-mobility vehicle 104 and no alternate routes may be suggested. For example, if the current speed associated with the micro-mobility vehicle 104 is 5 mph, and the speed limit is 10 mph for the current travel route 114A, the electronic apparatus 102 may not suggest the safer alternate route 114B. Whereas, if the speed limit is 10 mph and the current speed is more than 10 mph, the safer alternate route 1146 may be suggested and control may pass to 510.

At 510, the display device 110A may be controlled. In an embodiment, the electronic apparatus 102 may control the display device 110A to display an option to replace the current travel route 114A with the safer alternate route 114B. For example, based on the comparison between the current speed of the micro-mobility vehicle 104 and the speed limit associated with the current travel route 114A, the electronic apparatus 102 may send control instructions to the display device 110A to display the safer alternate route 114B and an option to replace the current travel route 114A with the safer alternate route 114B. The comparison may determine whether the current speed associated with the micro-mobility vehicle 104 exceeds the speed limit at which occurrence of incidents are above a threshold (also referred to as medium or high in table 3).

At 512, a safer alternate route option may be displayed. In an embodiment, the display device 110A may display the safer alternate route 114B and the option to replace the current travel route 114A with the safer alternate route 114B. For example, based on the control instructions from the electronic apparatus 102, the display device 110A may display the safer alternate route 114B and the option to replace the current travel route 114A with the safer alternate route 114B.

At 514, a user input may be received. In an embodiment, the electronic apparatus 102 may receive a user input from the display device 110A. For example, the display device 110A may display the current travel route 114A, the safer alternate route 114B, and the selection interface 114C through which either the current travel route 114A or the safer alternate route 114B may be selected. Based on a user selection via the selection interface 114C (such as the selection of the safer alternate route 114B or rejection of the safer alternate route 114B), the user device 110 may send the user input to the electronic apparatus 102. If the user input relates to the selection of the safer alternate route 114B, control may pass to 416 and operations from 416 to 420 may be executed. Whereas, if the user input corresponds to the rejection of the safer alternate route 114B, control may pass to 516.

At 516, the electronic speed-control mechanism 104A may be controlled. In an embodiment, the electronic apparatus 102 may control the electronic speed-control mechanism 104A to reduce the current speed below the speed limit based on a comparison of the current speed and the speed limit associated with the current travel route 114A. In another embodiment, the electronic apparatus 102 may control the electronic speed-control mechanism 104A further based on a determination that the user input is related to the rejection of the safer alternate route 114B.

For example, if the current speed of the micro-mobility vehicle 104 exceeds the speed limit associated with the current travel route 114A or If the user input relates to the rejection of the safer alternate route 114B, the electronic apparatus 102 may be configured to control the electronic speed-control mechanism 104A to reduce the current speed below the speed limit associated with the current travel route 114A.

At 518, the micro-mobility vehicle 104 may be controlled to apply a brake. In an embodiment, the electronic apparatus 102 may control the micro-mobility vehicle 104 to apply a brake for a set duration. For example, in case the safer alternate route 114B is rejected, the electronic apparatus 102 may control the micro-mobility vehicle 104 to apply the brake for a set duration to limit the current speed of movement of the micro-mobility vehicle 104. Such application of the brake may ensure safety of the rider.

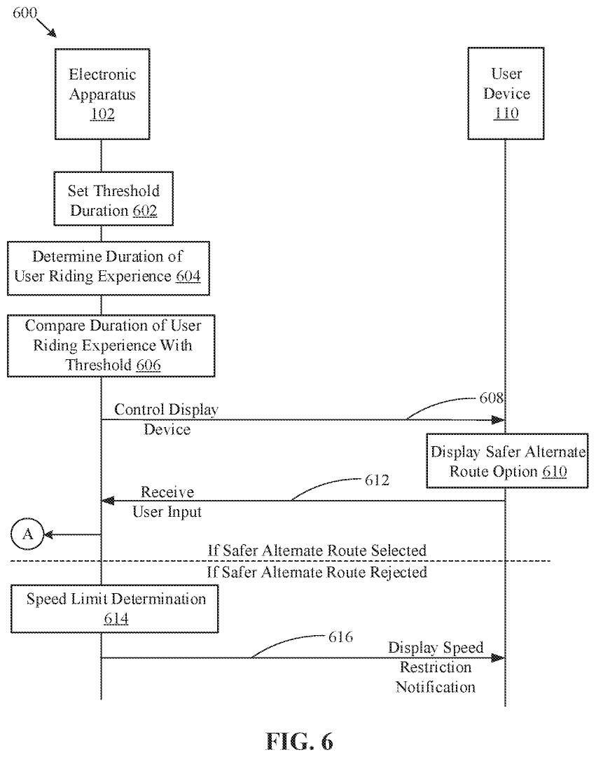

FIG. 6 is a sequence diagram that illustrates exemplary operations for a speed control of the micro-mobility vehicle based on user's riding experience with the micro-mobility vehicle, in accordance with an embodiment of the disclosure. FIG. 6 is described in conjunction with FIGS. 1, 2, 3, 4, and 5. With reference to FIG. 6, there is shown a sequence flow diagram 600 of exemplary operations. The exemplary operations may start from 602 and may performed by any suitable computing system or device, such as by the electronic apparatus 102 of FIG. 1 or FIG. 2. In FIG. 6, the exemplary operations from 602 to 616 relate to a speed control of the micro-mobility vehicle 104 based on user's riding experience associated with the user identifier.

At 602, a threshold duration of user riding experience may be set. For example, the electronic apparatus 102 may set the threshold duration of user riding experience. The threshold duration may be used to determine whether the current travel route 114A should be replaced with the safer alternate route 114B. In an embodiment, the electronic apparatus 102 may set the threshold duration of experience based on historical data that may relate hours of usage of the micro-mobility vehicle 104 with a number of past traffic incidents.

At 604, a duration of user riding experience may be determined. In an embodiment, the electronic apparatus 102 may be configured to determine the duration of user riding experience associated with the user identifier. For example, the shared mobility service server 106 may store the duration of user riding experience associated with the user identifier and may send the stored duration of user riding experience to the electronic apparatus 102. In another embodiment, the electronic apparatus 102 may be configured to determine the duration of user riding experience associated the micro-mobility vehicle 104 based on vehicle usage information associated with the user identifier. For example, the vehicle usage information may include several records linked to a specific user identifier. Each of such records may include a time stamp or a period (e.g., in hours) for which the micro-mobility vehicle 104 may have been operated in past by the rider associated with the specific user identifier.

At 606, the duration of user riding experience may be compared with the threshold duration. In an embodiment, the electronic apparatus 102 may be configured to compare the duration of user riding experience with the set threshold duration.

At 608, the display device 110A may be controlled. In an embodiment, the electronic apparatus 102 may control the display device 110A to display an option to replace the current travel route 114A with the safer alternate route 114B. For example, based on the comparison between the threshold duration and the duration of user riding experience, the electronic apparatus 102 may send control instructions to the display device 110A to display an option to replace the current travel route 114A with the safer alternate route 114B.

At 610, an option to replace the current travel route 114A with the safer alternate route 114B may be displayed. In an embodiment, the display device 110A may display the option to replace the current travel route 114A with the safer alternate route 114B based on the control instructions (at 608) from the electronic apparatus 102. In some embodiments, based on a determination that the duration of user riding experience is less than the threshold duration, the electronic apparatus 102 may replace the current travel route 114A with the safer alternate route 114B without displaying the option. In some other embodiments, based on a determination that the duration of user riding experience is more than the threshold duration, the current travel route 114A may not be replaced.

At 612, a user input may be received. In an embodiment, the electronic apparatus 102 may receive the user input from the display device 110A. For example, the display device 110A may display the current travel route 114A, the safer alternate route 114B, and the selection interface 114C through which either the current travel route 114A or the safer alternate route 114B may be selected. Based on a user selection via the selection interface 114C (such as a selection of the safer alternate route 114B or a rejection of the safer alternate route 114B), the display device 110A may send the user input to the electronic apparatus 102. If the user input corresponds to the selection of the safer alternate route 114B, control may pass to 416 and operations from 416 to 420 may be executed. Whereas, if the user input corresponds to the rejection of the safer alternate route 114B, control may pass to 614.

At 614, a speed limit for the micro-mobility vehicle 104 in at least one portion of the current travel route 114A may be determined. In an embodiment, the electronic apparatus 102 may determine the speed limit for the micro-mobility vehicle 104 in the at least one portion of the current travel route 114A based on the determined duration of user riding experience. By way of example, and not limitation, the speed limit may define a maximum permissible speed of the micro-mobility vehicle 104 on the current travel route 114A or the safer alternate route 114B.

In an embodiment, the electronic apparatus 102 may send control instructions to the electronic speed-control mechanism 104A to restrict the maximum permissible speed of the micro-mobility vehicle 104 to the determined speed limit based on the duration of user riding experience associated with the user identifier. For example, in case the riding experience associated with the user identifier is less than the threshold duration, the electronic apparatus 102 may send control instructions to the electronic speed-control mechanism 104A to restrict the maximum permissible speed of the micro-mobility vehicle 104 to the determined speed limit. In another embodiment, based on a determination that the duration of user riding experience is more than the threshold duration, the electronic apparatus 102 may send control instructions to the electronic speed-control mechanism 104A to increase the speed limit for the micro-mobility vehicle 104. The increase in the speed limit may result in increase in the maximum permissible speed of the micro-mobility vehicle 104 on the current travel route 114A or the safer alternate route 1146.

An example of various speed limits for different durations of user riding experience is presented in Table 5, as follows:

TABLE 5
Example of speed limits for different
durations of user riding experience

| Riding Experience | Speed Limit (Max Permissible Speed) |
|---|---|
| Less than 5 hours | 5 mph |
| Less than 10 hours | 10 mph |
| Greater than 20 hours | 30 mph |

In Table 5, in case the duration of user riding experience is less than 5 hours, the electronic apparatus 102 may send the control instructions to the electronic speed-control mechanism 104A to restrict the maximum permissible speed of the micro-mobility vehicle 104 to 5 mph (i.e. the speed limit). In case the duration of user riding experience is less than 10 hours, the electronic apparatus 102 may send the control instructions to the electronic speed-control mechanism 104A to restrict the maximum permissible speed of the micro-mobility vehicle 104 to 10 mph (i.e. the speed limit). In case the duration of user riding experience exceeds 20 hours, the electronic apparatus 102 may send the control instructions to the electronic speed-control mechanism 104A to restrict the maximum permissible speed of the micro-mobility vehicle 104 to 30 mph (i.e. the speed limit). In an embodiment, in case the duration of user riding experience exceeds a set threshold (such as 20 hours), the electronic apparatus 102 may remove the speed limit on the current travel route 114A (or the safer alternate route 114B), resulting in removal of any restriction on the maximum permissible speed of the micro-mobility vehicle 104. Data provided in Table 5 is merely experimental data and should not be construed as limiting for the present disclosure.

At 616, a notification may be displayed on the display device 110A. In an embodiment, the electronic apparatus 102 may control the display device 110A to display a notification which includes at least one of the determined speed limit or reduction in a current speed of the micro-mobility vehicle 104 below the determined speed limit. Additionally, or alternatively, the display device 110A may display a notification (such as a speed restriction notification) based on a determination that the maximum permissible speed of the micro-mobility vehicle 104 is restricted to the speed limit.

For example, in case the maximum permissible speed is restricted to 10 mph, the display device 110A may be configured to display the speed restriction notification as, “Your speed limit is 10 mph” or “Your speed restricted to a speed limit of 10 mph”). As another example, if the maximum permissible speed is restricted to 30 mph, the display device 110A may be configured to display the speed restriction notification as, “Your speed limit is set to 30 mph!”. Such a restriction on the maximum permissible speed of the micro-mobility vehicle 104 may further improve safety of the rider.

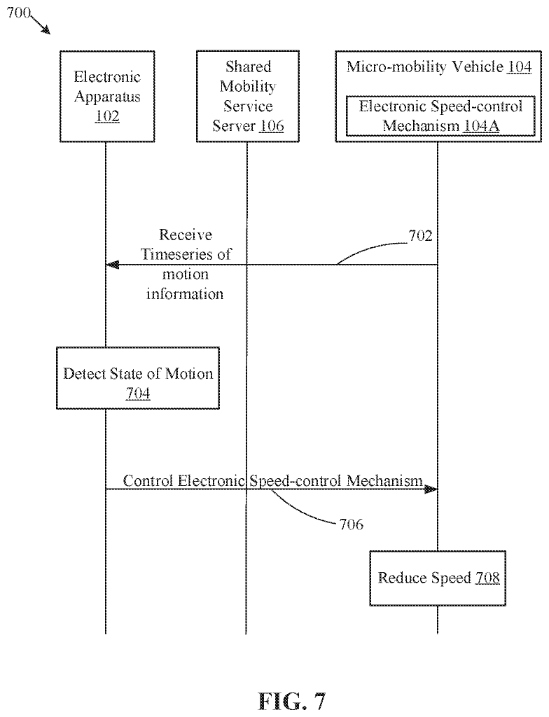

FIG. 7 is a sequence diagram that illustrates exemplary operations for a speed control of the micro-mobility vehicle based on a vehicle state, in accordance with an embodiment of the disclosure. FIG. 7 is described in conjunction with FIGS. 1, 2, 3, 4, 5, and 6. With reference to FIG. 7, there is shown a sequence flow diagram 700 of exemplary operations. The exemplary operations may start from 702 and may performed by any suitable computing system or device, such as by the electronic apparatus 102 of FIG. 1 or FIG. 2. In FIG. 7, the exemplary operations from 702 to 708 relate to a speed control of the micro-mobility vehicle 104 based on a vehicle state.

At 702, a timeseries of motion information may be received. In an embodiment, the electronic apparatus 102 may receive the timeseries of motion information associated with the micro-mobility vehicle 104. For example, the timeseries of motion information may be acquired by the sensor system 210 (e.g. an accelerometer or a GNSS receiver) of the electronic apparatus 102. As another example, the timeseries of motion information may be acquired by a sensor system of the micro-mobility vehicle 104 and the acquired information may be transmitted to the electronic apparatus 102. As another example, an accelerometer or a GNSS receiver may be mounted on the handlebar of the micro-mobility vehicle 104. In an embodiment, the electronic apparatus 102 may receive the timeseries of motion information from the shared mobility service server 106.

At 704, a state of motion of the micro-mobility vehicle 104 may be detected. In an embodiment, the electronic apparatus 102 may detect the state of motion of the micro-mobility vehicle 104 as one of an unstable state or a stable state based on the received timeseries of motion information. For example, if the received timeseries of motion information indicates a wobbly motion of the micro-mobility vehicle 104, the electronic apparatus 102 may detect the state of motion of the micro-mobility vehicle 104 as unstable. The unstable state of the micro-mobility vehicle 104 may be indicative of a lower experience level or a lower confidence of the rider while riding the micro-mobility vehicle 104 on the current travel route 114A or the safer alternate route 114B.

At 706, the electronic speed-control mechanism 104A may be controlled. In an embodiment, the electronic apparatus 102 may send control instructions to the electronic speed-control mechanism 104A based on the detected state of motion of the micro-mobility vehicle 104. For example, if the state of motion of the micro-mobility vehicle 104 is unstable, the electronic apparatus 102 may control the electronic speed-control mechanism 104A to reduce the speed of the micro-mobility vehicle 104. The speed may be reduced as part of a pre-emptive measure to ensure safety of the rider riding the micro-mobility vehicle 104. In another embodiment, the electronic speed-control mechanism 104A may be controlled to control the current speed of the micro-mobility vehicle 104 in accordance with a speed limit. For example, the speed limit may be associated with the duration of user riding experience with the micro-mobility vehicle 104.

At 708, the current speed of the micro-mobility vehicle 104 may be reduced. In an embodiment, the electronic speed-control mechanism 104A may reduce the current speed of the micro-mobility vehicle 104 based on the control instructions from the electronic apparatus 102. For example, in case of the unstable state, the electronic speed-control mechanism 104A may reduce the current speed of the micro-mobility vehicle 104 to restore the motion of the micro-mobility vehicle 104 to a stable state. Such a control of the current speed of the micro-mobility vehicle 104 based on the state of motion of the micro-mobility vehicle 104 may ensure safety of both the rider and the micro-mobility vehicle 104.

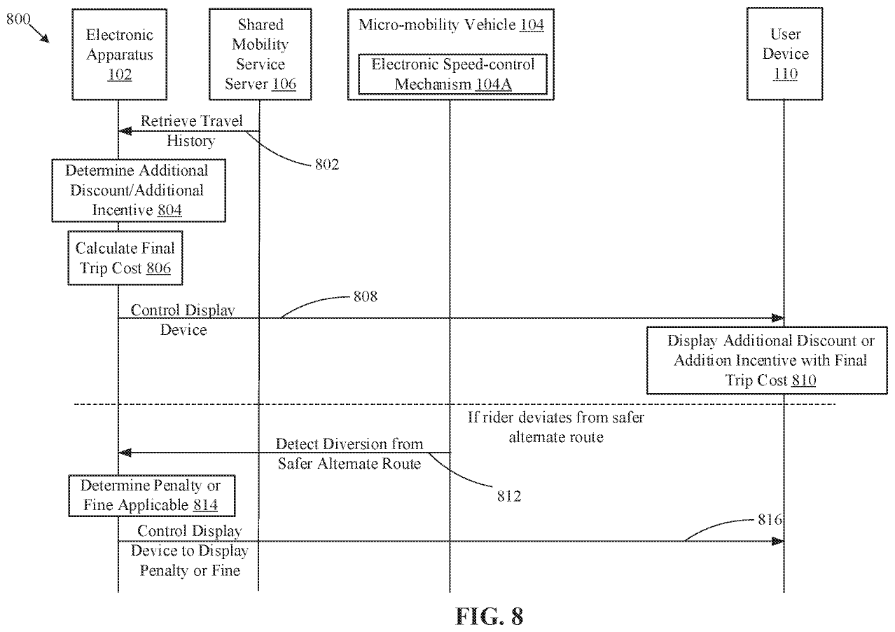

FIG. 8 is a sequence diagram that illustrates exemplary operations for providing additional incentives or penalties on a final trip cost based on a user behavior during a trip, in accordance with an embodiment of the disclosure. FIG. 8 is described in conjunction with FIGS. 1, 2, 3, 4, 5, 6 and 7. With reference to FIG. 8, there is shown a sequence diagram 800 of exemplary operations. The exemplary operations may start from 802 and may performed by any suitable computing system or device, such as by the electronic apparatus 102 of FIG. 1 or FIG. 2. In FIG. 8, the exemplary operations from 802 to 816 relate to a provision for additional incentives or penalties on a final trip cost based on a user behavior.

At 802, a travel history may be retrieved. In an embodiment, the electronic apparatus 102 may retrieve the travel history (such as the travel history 302E associated with the user identifier) from the shared mobility service server 106. For example, the shared mobility service server 106 may be configured to store information on each ride of the rider and generate the travel history. The travel history may be indicative of a user preference for safer alternate routes in the past. The shared mobility service server 106 may then transmit the stored travel history to the electronic apparatus 102.

At 804, an additional discount or an additional incentive may be determined. In an embodiment, the electronic apparatus 102 may determine one of: an additional discount applicable on the initial trip cost or an additional incentive based on the retrieved travel history. The determined additional discount or the determined additional incentive may be applicable on the initial trip cost in addition to the determined discount (e.g., at 416 of FIG. 4) and may be a reward for the rider for a good behavior in past. Such a good behavior may be measured from the travel history by counting a number of times the rider may have selected safer alternate routes in the past.

At 806, the final trip cost may be calculated. In an embodiment, the electronic apparatus 102 may calculate the final trip cost associated with the trip plan 114 based on the additional discount or the additional incentive. For example, in case the travel history indicates an increase in number of safer alternate route selections, the electronic apparatus 102 may determine an additional discount on the initial trip cost associated with the trip plan 114 and calculate the final trip cost based on the additional discount. As another example, the electronic apparatus 102 may provide the additional incentive in the form of points, which can be redeemed after a preset number of rides (e.g. five rides) with various safer alternate routes. The accumulated points may be redeemed to obtain a free ride in a subsequent trip.

At 808, the display device 110A may be controlled. In an embodiment, the electronic apparatus 102 may control the display device 110A to display the calculated final trip cost. For example, the electronic apparatus 102 may send control instructions to the display device 110A to display the final trip cost associated with the trip plan 114.

At 810, the additional discount with final trip cost may be displayed. In an embodiment, the display device 110A may be configured to display the additional discount along with the final trip cost. For example, the display device 110A may include the output interface 114D that may be configured to display the additional discount along with the final trip cost. The additional discount may be displayed to encourage and incentivize the rider to opt for safer alternate routes in future.

At any time-instant, if the rider is found to deviate from the safer alternate route 1146 after the safer alternate route 1146 is selected, the rider may be penalized or fined. Such a scenario is discussed from 812 to 816.

At 812, a diversion from the safer alternate route 114B may be detected. In an embodiment, the electronic apparatus 102 may be configured to detect, within a duration of the trip plan 114, a movement of the micro-mobility vehicle 104 on a third travel route which may be different from the safer alternate route 114B. For example, such movement may be detected based on location information acquired from the sensor system 210 of the electronic apparatus 102.

At 814, a penalty or a fine may be determined. In an embodiment, the electronic apparatus 102 may determine the penalty or the fine based on the detected movement. The penalty or the fine may be applicable on the final trip cost associated the trip plan 114.

At 816, the display device 110A may be controlled to display the penalty or the fine. In an embodiment, the electronic apparatus 102 may be configured to control the display device 110A to display the penalty or the fine applicable on the final trip cost associated the trip plan 114. Such control may be based on the detected movement. In an embodiment, the penalty or the fine may include a value which cancels the discount offered on the initial trip cost.

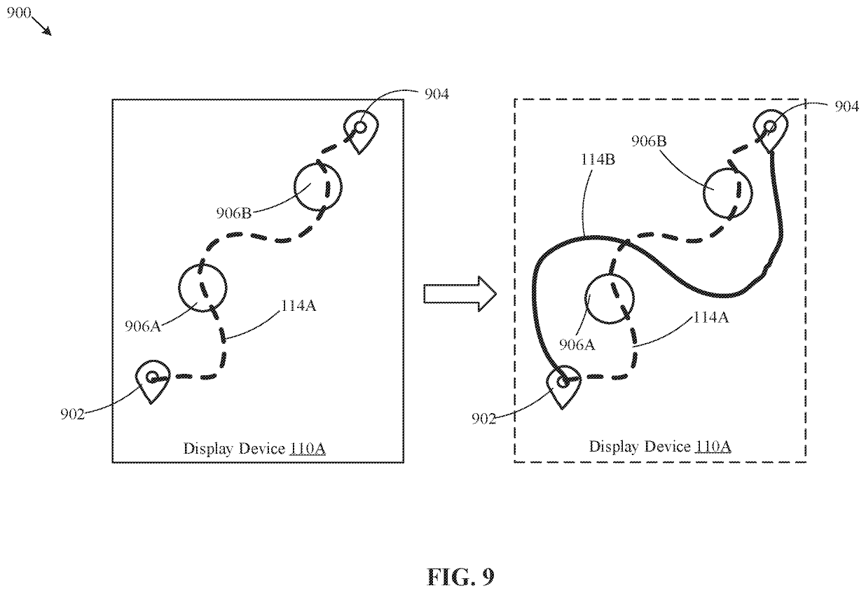

FIG. 9 is an exemplary scenario diagram that illustrates exemplary operations to promote rider safety, in accordance with an embodiment of the disclosure. FIG. 9 is described in conjunction with FIGS. 1, 2, 3, 4, 5, 6, 7, 8, and 9. With reference to FIG. 9, there is shown a scenario diagram 900 to promote safety of the rider. In the scenario diagram 900, there is shown the display device 110A associated with the micro-mobility vehicle 104. Based on the user input, the display device 110A may display the current travel route 114A (shown in a dashed line). The current travel route 114A may include a starting point 902 and a destination point 904. In an embodiment, the display device 110A may also display an incident map of the current travel route 114A that indicates multiple traffic incident areas such as a first traffic incident area 906A and a second traffic incident area 906B. Based on the number of traffic incidents, the electronic apparatus 102 may be configured to display the safer alternate route 114B to ensure safety of the rider.

In an embodiment, the starting point 902 and the destination point 904 are the same for both the current travel route 114A and the safer alternate route 114B. The electronic apparatus 102 may determine the safer alternate route 114B in such a way that the number of past traffic incidents on the safer alternate route 114B are less (or substantially less) as compared to the number of past traffic incidents on the current travel route 114A. Upon selection of the safer alternate route 114B, the initial trip cost may be discounted as a reward for a good behavior from the rider. In an embodiment, the electronic apparatus 102 may determine the safer alternate route 114B for only a portion of the current travel route 114A.

In another embodiment, the electronic apparatus 102 may be configured to determine characteristics of the first traffic incident area 906A to predict other areas of potential high incidents on the current travel route 114A or other travel routes different from the current travel route 114A. The electronic apparatus 102 may be configured to apply the re-routing principle with incentives and/or speed control strategy (as described with reference to FIGS. 4, 5, and 6) to the other travel routes to ensure safety of the rider on the other travel routes. The prediction of the other areas of potential high incidents may ensure the safety of the rider in case the incident information associated with the other travel routes is not generated.

FIG. 10 is a diagram of an exemplary micro-mobility vehicle, in accordance with an embodiment of the disclosure. FIG. 10 is described in conjunction with FIGS. 1, 2, 3, 4, 5, 6, 7, 8, and 9. With reference to FIG. 10, there is shown a diagram 1000 of an e-scooter as an exemplary implementation of the micro-mobility vehicle 104 of FIG. 1. The user 116 is shown as a rider of the micro-mobility vehicle 104.

The micro-mobility vehicle 104 includes an in-built electronic apparatus 1002, the electronic speed-control mechanism 104A, an in-vehicle display device 1004B, and an in-built sensor system 1004C. The in-built electronic apparatus 1002 may be an exemplary implementation of the electronic apparatus 102 of FIG. 1.

In FIG. 1, the electronic apparatus 102 and the display device 110A are shown as separate entities from the micro-mobility vehicle 104. However, the disclosure may be not so limiting, and in FIG. 10, the micro-mobility vehicle 104 may integrally include the in-built electronic apparatus 1002 and the in-vehicle display device 1004B, without a deviation from scope of the disclosure. The functions of the in-built electronic apparatus 1002 may be same as the functions of the electronic apparatus 102 as described, for example, in FIG. 1 or FIG. 2. The functions of the in-vehicle display device 1004B may be same as the functions of the display device 110A as described, for example, in FIG. 1. Therefore, the description of the in-built electronic apparatus 1002 and the in-vehicle display device 1004B are omitted from the disclosure for the sake of brevity.

Further, the functions of the in-built sensor system 1004C may be same as the functions of the sensor system 210 as described, for example, in FIG. 2. In addition to the functions of the sensor system 210, the in-built sensor system 1004C may detect the current speed based on measurement of parameters, such as engine revolutions, gear ratio, or a wheel Rotation Per Minute (RPM).

In an embodiment, the in-built electronic apparatus 1002 may be an in-vehicle control system that may be integrated with the micro-mobility vehicle 104. The in-vehicle control system may include suitable logic, circuitry, interfaces and/or code that may be configured to present at least audio-based data, video-based data, and a user interface for the micro-mobility vehicle 104. Examples of the in-vehicle control system may include, but are not limited to, an entertainment system, a navigation system, a vehicle user interface (UI), an Internet-enabled communication system, and other communication systems.

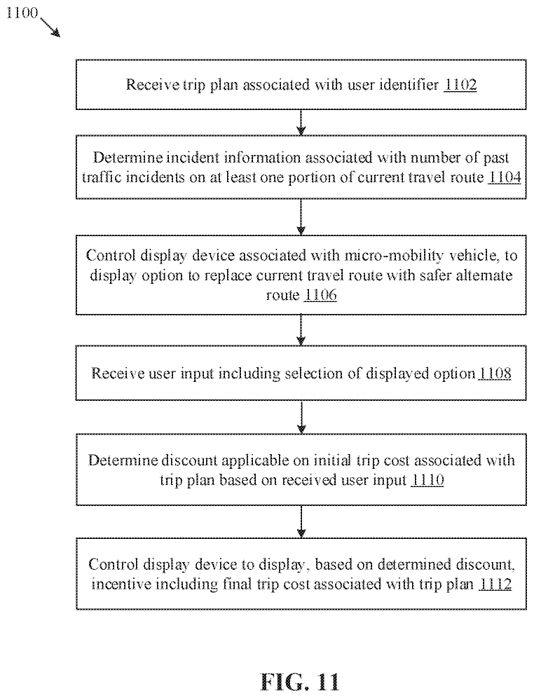

FIG. 11 is a flowchart that illustrates exemplary operations to promote rider safety in a shared mobility space, in accordance with an embodiment of the disclosure. The flowchart 1100 is described in conjunction with FIGS. 1, 2, 3, 4, 5, 6, 7, 8, 9, and 10. With reference to FIG. 11, there is shown a flowchart 1100 that may include operations from 1102 to 1112. The operations from 1102 to 1112 may be implemented, for example, by the electronic apparatus 102 of FIG. 1 or FIG. 2. The operations of the flowchart 1100 may start at 1102.

At 1102, the trip plan 114 associated with a user identifier may be received. In an embodiment, the electronic apparatus 102 may receive the trip plan 114 associated with the user identifier, as described, for example, in FIG. 4 (such as at 402).

At 1104, incident information associated with a number of past traffic incidents may be determined on at least one portion of the current travel route 114A. In an embodiment, the electronic apparatus 102 may determine the incident information associated with the number of past traffic incidents on at least one portion of the current travel route 114A, as described, for example, in FIG. 4.

At 1106, the display device 110A associated with the micro-mobility vehicle 104 may be controlled to display an option to replace the current travel route 114A with the safer alternate route 114B. In an embodiment, the electronic apparatus 102 may control the display device 110A to display the option to replace the current travel route 114A with the safer alternate route 114B, as described, for example, in FIG. 1, and in FIG. 4.

At 1108, a user input including a selection of the displayed option may be received. In an embodiment, the electronic apparatus 102 may receive the user input which includes the selection of the displayed option, as described, for example, in FIG. 1, and in FIG. 4.

At 1110, a discount applicable on the initial trip cost associated with the trip plan 114 may be determined based on the received user input. In an embodiment, the electronic apparatus 102 may determine the discount applicable on the initial trip cost based on the received user input, as described, for example, in FIG. 4.

At 1112, the display device 110A may be controlled to display an incentive including the final trip cost associated with the trip plan 114. The incentive may be displayed based on the determined discount. In an embodiment, the electronic apparatus 102 may control the display device 110A to display the incentive including the final trip cost associated with the trip plan 114, as described, for example, in FIG. 4. Control may pass to end.

Although the flowchart 1100 is illustrated as discrete operations, such as 1102, 1104, 1106, 1108, 1110, and 1112, the disclosure may not be so limited. Accordingly, in certain embodiments, such discrete operations may be further divided into additional operations, combined into fewer operations, or eliminated, depending on the particular implementation without detracting from the essence of the disclosed embodiments.

Various embodiments of the disclosure may provide a non-transitory, computer-readable medium and/or storage medium, and/or a non-transitory machine readable medium and/or storage medium stored thereon, a set of instructions executable by a machine and/or a computer to provide safety for the rider. The set of instructions may be executable by the machine and/or the computer (for example the electronic apparatus 102) to perform operations that may include receiving a trip plan associated with a user identifier, the trip plan including a current travel route of a micro-mobility vehicle associated with a shared mobility service. The operations may further include determining incident information associated with a number of past traffic incidents on at least one portion of the current travel route. The operations may further include controlling a display device associated with the micro-mobility vehicle, to display an option to replace the current travel route with a safer alternate route. The option to replace the current travel route is displayed based on the determined incident information. The operations may further include receiving a user input including a selection of the displayed option. The operations may further include determining a discount applicable on an initial trip cost associated with the trip plan based on the received user input. The operations may further include controlling the display device to display, based on the determined discount, an incentive including a final trip cost associated the trip plan.

Although the present disclosure relates to shared mobility service, the present disclosure may also be implemented to provide incentive for a new vehicle at the time of purchase to provide safety to the owner of the vehicle. The present disclosure may be realized in hardware, or a combination of hardware and software. The present disclosure may be realized in a centralized fashion, in at least one computer system, or in a distributed fashion, where different elements may be spread across several interconnected computer systems. A computer system or other apparatus adapted for carrying out the methods described herein may be suited. A combination of hardware and software may be a general-purpose computer system with a computer program that, when loaded and executed, may control the computer system such that it carries out the methods described herein. The present disclosure may be realized in hardware that includes a portion of an integrated circuit that also performs other functions. It may be understood that, depending on the embodiment, some of the steps described above may be eliminated, while other additional steps may be added, and the sequence of steps may be changed.

The present disclosure may also be embedded in a computer program product, which includes all the features that enable the implementation of the methods described herein, and which when loaded in a computer system is able to carry out these methods. Computer program, in the present context, means any expression, in any language, code or notation, of a set of instructions intended to cause a system with an information processing capability to perform a particular function either directly, or after either or both of the following: a) conversion to another language, code or notation; b) reproduction in a different material form. While the present disclosure has been described with reference to certain embodiments, it will be understood by those skilled in the art that various changes may be made, and equivalents may be substituted without departing from the scope of the present disclosure. In addition, many modifications may be made to adapt a particular situation or material to the teachings of the present disclosure without departing from its scope. Therefore, it is intended that the present disclosure is not limited to the particular embodiment disclosed, but that the present disclosure will include all embodiments that fall within the scope of the appended claims.

What is claimed is:

1. An electronic apparatus, comprising:
circuitry configured to:
receive a trip plan associated with a user identifier, the trip plan comprising a current travel route of a micro-mobility vehicle associated with a shared mobility service;
determine incident information associated with a number of past traffic incidents on at least one portion of the current travel route;
control a display device associated with the micro-mobility vehicle, to display an option to replace the current travel route with a safer alternate route,
wherein the option to replace the current travel route is displayed based on the determined incident information;
receive a user input comprising a selection of the displayed option;
determine a discount applicable on an initial trip cost associated with the trip plan based on the received user input; and
control the display device to display, based on the determined discount, an incentive comprising a final trip cost associated the trip plan.

2. The electronic apparatus according to claim 1, wherein the circuitry is further configured to determine the safer alternate route that includes a destination location which is same as a destination location of the current travel route.

3. The electronic apparatus according to claim 1, wherein the circuitry is further configured to determine a speed limit for the micro-mobility vehicle in the at least one portion of the current travel route,
wherein the speed limit is determined based on at least one of the determined incident information or a legal maximum speed for the at least one portion of the current travel route.

4. The electronic apparatus according to claim 3, wherein the circuitry is configured to control the display device to display the option further based on a determination that a current speed of the micro-mobility vehicle is above the determined speed limit.

5. The electronic apparatus according to claim 3, wherein the circuitry is further configured to control an electronic speed-control mechanism of the micro-mobility vehicle to reduce a current speed of the micro-mobility vehicle below the determined speed limit.

6. The electronic apparatus according to claim 5, wherein the electronic speed-control mechanism is controlled based on a determination that the received user input relates to a rejection of the displayed option to replace the current travel route of the trip plan with the safer alternate route.

7. The electronic apparatus according to claim 1, wherein the circuitry is further configured to determine the safer alternate route that is associated with a second number of past traffic incidents, the second number of past traffic incidents is less than a first number of past traffic incidents associated with the current travel route.

8. The electronic apparatus according to claim 1, wherein the circuitry is further configured to determine a duration of user riding experience associated the micro-mobility vehicle based on vehicle usage information associated with the user identifier.

9. The electronic apparatus according to claim 8, wherein the circuitry is further configured to replace the current travel route with the safer alternate route based on a determination that the duration of user riding experience is below a threshold duration.

10. The electronic apparatus according to claim 8, wherein the circuitry is further configured to:
determine a speed limit for the micro-mobility vehicle in the at least one portion of the current travel route based on the determined duration of user riding experience; and
control the display device to display a notification comprising at least one of the determined speed limit or reduction in a current speed of the micro-mobility vehicle below the determined speed limit.

11. The electronic apparatus according to claim 1, wherein the circuitry is further configured to:
receive information of a day of week and a travel period associated with the trip plan; and
select, from an incident database, the number of past traffic incidents which occurred in the past on the day of week and within the travel period,
wherein the determined incident information is associated with the selected number of past traffic incidents.

12. The electronic apparatus according to claim 1, wherein the circuitry is further configured to detect a state of motion of the micro-mobility vehicle as one of: an unstable state or a stable state based on a timeseries of motion information associated with the micro-mobility vehicle.

13. The electronic apparatus according to claim 12, wherein the circuitry is further configured to control an electronic speed-control mechanism of the micro-mobility vehicle based on the detected state,
wherein the electronic speed-control mechanism is controlled to control a current speed of the micro-mobility vehicle in accordance with a speed limit, the speed limit is associated with a duration of user riding experience with the micro-mobility vehicle.

14. The electronic apparatus according to claim 1, wherein the circuitry is further configured to control the micro-mobility vehicle to apply a brake for a set duration, wherein the micro-mobility vehicle is controlled based on a determination that the received user input relates to a rejection of the displayed option to replace the current travel route of the trip plan with the safer alternate route.

15. The electronic apparatus according to claim 1, wherein the circuitry is further configured to calculate the final trip cost by subtracting the determined discount from the initial trip cost.

16. The electronic apparatus according to claim 1, wherein the circuitry further configured to:
retrieve a travel history indicative of a user preference for safer alternate routes in the past;
determine one of: an additional discount applicable on the initial trip cost or an additional incentive based on the retrieved travel history; and
calculate the final trip cost associated the trip plan based on the determined additional discount or the additional incentive.

17. The electronic apparatus according to claim 1, wherein the circuitry further configured to:
detect, within a duration of the trip plan, a movement of the micro-mobility vehicle on a third travel route which is different from the safer alternate route; and
control the display device to display, based on the detected movement, a penalty or a fine applicable on the final trip cost associated the trip plan.

18. A method, comprising:
in an electronic apparatus:
receiving a trip plan associated with a user identifier, the trip plan comprising a current travel route of a micro-mobility vehicle associated with a shared mobility service;
determining incident information associated with a number of past traffic incidents on at least one portion of the current travel route;
controlling a display device associated with the micro-mobility vehicle, to display an option to replace the current travel route with a safer alternate route,
wherein the option to replace the current travel route is displayed based on the determined incident information;
receiving a user input comprising a selection of the displayed option;
determining a discount applicable on an initial trip cost associated with the trip plan based on the received user input; and
controlling the display device to display, based on the determined discount, an incentive comprising a final trip cost associated the trip plan.

19. The method according to claim 18, further comprising:
determining a speed limit for the micro-mobility vehicle in the at least one portion of the current travel route,
wherein the speed limit is determined based on at least one of the determined incident information or a legal maximum speed for the at least one portion of the current travel route; and
controlling the display device to display the option further based on a determination that a current speed of the micro-mobility vehicle is above the determined speed limit.

20. A non-transitory computer-readable medium having stored thereon, computer-executable instructions which, when executed by an electronic apparatus, cause the electronic apparatus to execute operations, the operations comprising:
receiving a trip plan associated with a user identifier, the trip plan comprising a current travel route of a micro-mobility vehicle associated with a shared mobility service;
determining incident information associated with a number of past traffic incidents on at least one portion of the current travel route;
controlling a display device associated with the micro-mobility vehicle, to display an option to replace the current travel route with a safer alternate route,
wherein the option to replace the current travel route is displayed based on the determined incident information;
receiving a user input comprising a selection of the displayed option;
determining a discount applicable on an initial trip cost associated with the trip plan based on the received user input; and
controlling the display device to display, based on the determined discount, an incentive comprising a final trip cost associated the trip plan.
